(19) United States
(12) Patent Application Publication
(10) Pub. No.: US 2016/0371724 A1
(43) Pub. Date: Dec. 22, 2016

(54) CALL ROUTING IN LEAD MANAGEMENT SYSTEMS

(71) Applicant: Underground Elephant, San Diego, CA (US)

(72) Inventors: Jason Kulpa, San Diego, CA (US); Keola Malone, San Diego, CA (US); Jovel Lacson, Chula Vista, CA (US); Kevin McCarroll, San Diego, CA (US); Aaron Scherer, San Diego, CA (US)

(21) Appl. No.: 14/987,608

(22) Filed: Jan. 4, 2016

Related U.S. Application Data
(60) Provisional application No. 62/182,427, filed on Jun. 19, 2015.

(51) Int. Cl. G06Q 30/02; H04M 3/51

(52) U.S. Cl. CPC G06Q 30/0246; H04M 3/5158

(57) ABSTRACT

Routing telephone-based sales leads through a sales lead management system. A sales lead vendor can provide telephone-based sales lead information to a lead management system. The lead management system can match the telephone based sales lead to a sales lead buyer and provide an indication of an amount that the sales lead buyer will pay for the sales lead. The sales lead management system can management the transfer of a telephone call associated with the telephone-based sales lead.

### CROSS-REFERENCE TO RELATED APPLICATION

This application claims priority under 35 U.S.C. §119(e) to U.S. Provisional Patent Application Ser. No. 61/937,420 filed on Feb. 7, 2014 and titled “System and Method for Creating, Managing and Fulfilling Sales Lead Orders” and U.S. patent application Ser. No. 14/617,893 filed on Feb. 7, 2015 and titled “System and Method for Creating, Managing and Fulfilling Sales Lead Orders” and U.S. Provisional Patent Application Ser. No. 62/158,462 filed on May 7, 2005, the disclosures of which are incorporated by reference herein in their entireties.

### TECHNICAL FIELD

The subject matter described herein relates to call routing, and specifically call routing in lead management systems.

### BACKGROUND

With the advent of digital marketing, sales agents have more resources than ever to reach potential customers (i.e. sales leads). However, these resources are disparate and modular, with limited opportunities for easy integration, causing confusion and inefficiency within full-cycle marketing processes (i.e. lead to conversion).

In general, the marketing process starts with sales. The value of sales leads is based on the amount, validity, applicability, exclusivity and age of information provided about a prospective consumer of a product or service. A maximum value per lead is achieved by optimally matching individual leads with individual buyer's specific criteria. Since sales leads are generated using relatively broad reach marketing strategies, it is necessary to have a large and diverse set of buyers in order to ensure the percentage of leads sold is as high as possible. Traditionally, the cost of integrating and supporting large quantities of sales lead buyers is prohibitively expensive. The result is low lead value, high buyer support costs, and/or high unsold lead percentages.

Lead acquisition platforms and lead management systems help agents initiate the sales process, but they are segmented from other critical marketing functionalities (CRM, policy quoting platforms, automated contact platforms, and email marketing systems), meaning sales agents cannot manage and complete the marketing and sales process, in its entirety, within a single platform. Instead of operating in a streamlined, integrated system, agents' marketing efforts and sales pipelines are bottlenecked by a disparate patchwork of technical solutions and temporary fixes (numerous API integrations and data exports). Furthermore, enterprise-level data (i.e. aggregate sales performance of agents at local, regional, and national level) goes largely underutilized, meaning agents do not know how they are doing compared to their peers.

### SUMMARY

The computer-implemented methods, software, and systems are presented for the management and fulfillment of an integrated marketing and sales process (i.e. a single marketing interface), as performed by sales agents.

In one aspect a method to be performed by one or more data processors forming at least part of a computing system is described. The method may comprise one or more operations. The method may comprise receiving, at the one or more data processors via a communications network, data representing an electronic request from a sales lead vendor system. The electronic request can include a subset of information associated with a telephone-based sales lead. The subset of information can be sufficient for matching the telephone-based sales lead with at least one of a plurality of sales lead buyers electronically represented in a database. The operations can include selecting, by the one or more data processors according to the subset of information, at least one sales lead buyer from the plurality of sales lead buyers in the database for the telephone-based sales lead. The selecting can include a purchase amount to be paid by each of the at least one sales lead buyer the telephone-based sales lead.

The operations can include transmitting, by the one or more data processors to each of the at least one sales buyer via the communication network, data representing an offer to purchase the telephone-based sales lead at the purchase amount. Data representing an acceptance of the offer can be received by the one or more data processors from at least one sales lead buyer via the communication network. Additional information associated with the telephone-based sales lead can be included in the data. A set of verification rules can be executed to verify the accuracy of the additional information associated with the telephone-based sales lead.

Data representing a telephone number of the at least one sales lead buyer can be transmitted, by the one or more data processors to the sales lead vendor via the communications network. The data can enable the sales lead vendor to transfer the telephone-based sales lead to the at least one sales lead buyer.

The operations can include monitoring, by the one or more data processors, one or more parameters associated with a telephone conversation between the telephone-based sales lead and the sales lead buyer based on the telephone number.

In some variations, an outcome of the telephone call between the telephone-based sales lead and the at least one sales lead buyer can be transmitted to the sales lead vendor, via the communication network. The transmitted outcome can include a duration of the telephone call and an indication of the amount paid to the sales lead vendor for the telephone-based sales lead.

The telephone conversation between the telephone-based sales lead and the at least one sales lead buyer can be recorded and analyzed. A quality assessment of the telephone-based sales leads can be determined based on the analysis of the telephone conversations.

In another aspect, systems comprising at least one processor and memory configured to include machine-readable instructions which when executed by the at least one processor cause the at least one processor to perform one or more of the operations herein described, are provided.

In other aspects a data storage memory is provided, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a graphical user interface used by prospective buyers to apply for access to purchase sales leads;

FIG. 2 depicts a graphical user interface used by buyers to quickly view the status of their account and orders;

FIG. 3 depicts a graphical user interface used at the beginning of the new order creation process;

FIG. 4 depicts the graphical user interface for Step 2 of the new order creation process;

FIG. 5 depicts a graphical user interface used to select the geographic location of sales leads;

FIG. 6 depicts a graphical user interface used by buyers to fund their account;

FIG. 7 depicts a graphical user interface that can be used to fund an order;

FIG. 8 depicts a graphical user interface used by buyers to view and manage leads purchased;

FIG. 9 depicts a graphical user interface illustrated in FIG. 8 after the filter menu collapsed;

FIG. 10 depicts a graphical user interface used to view detailed lead information when the Lead Details action button is used in FIG. 9;

FIG. 11 depicts a graphical user interface used by lead vendors to act on lead return requests;

FIG. 12 depicts a graphical user interface from FIG. 11 with the filter menu collapsed;

FIG. 13 depicts a graphical user interface used lead vendors to manage system users;

FIG. 14 depicts a graphical user interface used by lead vendors to view and manage billing transactions;

FIG. 15 depicts an example of a receipt created through the interface depicted in FIG. 14; and

FIG. 16 depicts a graphical user interface used by lead buyers and lead vendors to view leads previously made available for sale through the system;

FIG. 17 is a functional block diagram of a system for creating, managing and fulfilling sales lead orders;

FIG. 18 illustrates a process executed by the order creation module, in accordance with some implementations;

FIG. 19 illustrates a process executed by the lead management module, in accordance with some implementations;

FIG. 20 illustrates a process executed by the conversion tracking and disposition data module;

FIG. 21 is a process flow diagram illustrating aspects of a method having one or more features consistent with implementations of the current subject matter;

FIG. 22 is a process flow diagram illustrating aspects of a method having one or more features consistent with implementations of the current subject matter;

FIG. 23 is a process flow diagram illustrating aspects of a method having one or more features consistent with implementations of the current subject matter;

FIG. 24 is a process flow diagram illustrating aspects of a method having one or more features consistent with implementations of the current subject matter;

FIG. 25 is an illustration of lead information across verticals and lead clients that have been generated by a lead management system capable of performing one or more of the operations described herein;

FIG. 26 is an illustration of key performance indicators for sales leads that have been generated by a lead management system capable of performing one or more of the operations described herein;

FIGS. 27 and 28 are illustrations of incoming leads that have been received and filtered by a lead management system capable of performing one or more of the operations described herein;

FIG. 29 is an illustration of lead metrics filtered by different lead attributes that have been generated by a lead management system capable of performing one or more of the operations described herein;

FIG. 30 is an illustration of leads received by a lead management system capable of performing one or more of the operations described herein;

FIG. 31 is an illustration of a system for routing telephone calls through a lead management system, having one or more features consistent with the current subject matter;

FIG. 32 is an illustration of a process for routing calls through a lead management system, having one or more features consistent with the current subject matter; and,

FIG. 33 is an illustration of a process for routing calls through a lead management system, having one or more features consistent with the current subject matter.

When practical, similar reference numbers denote similar structures, features, or elements.

### DETAILED DESCRIPTION

The presently described subject matter provides solutions, systems, methods articles of manufacture and the like for routing calls through a sales lead management environment. The routing can depend on one or more features of the call.

In accordance with some implementations, a system can include a lead acquisition platform (LAP) that provides an interface allowing agents to acquire, manage, and fulfill sales lead orders from multiple vendors in a single marketing platform/system. Sales leads can be segmented based on product type, as well as consumer profiles and geography. Proprietary algorithms forecast lead volumes based on their respective market categories. Proprietary data hygiene ensures sales lead quality by verifying lead sources and protecting against fraud. This platform provides the ability to distribute and route leads to one or multiple interfaces, via email and application programming interfaces (API), delivering leads, and integrates with common third-party solutions. When sales leads result in sales (i.e. conversions), this lead-to-sale data is tracked in real-time, providing quote-to-close information at both the vendor and market-segment level in a single, integrated platform. Billing for platform users (e.g. sales agents) allows them to accept and process multiple payment types and allocate their budgets across multiple vendors in a single system.

The system can include a vendor management software (VMS) system and method that allows sales agents to perform the following functions in a single marketing interface: (a) manage vendors by activating/deactivating lead sources, (b) enterprise-level vendor management automation to grant/deny access to the system based on key compliance and performance indicators, (c) return leads from multiple vendors using API's to programmatically manage process, (d) conversion tracking by lead source, (e) integrate with other preferred VMS platforms.

The system can include a lead management software (LMS) system and method that allows agents to perform numerous functions in a single marketing interface. Lead disposition puts tags on sales leads, allowing agents to perform sales-cycle tracking. Centralized data storage delivers historical tracking of agent performance, and integrates with third party CRM platforms. The LMS system offers agents dynamic pricing and bidding, which is driven by the system's ping post functionality, along with the underlying algorithms for programmatic buying and selling, as well as predictive revenue, cost, and quality of sales leads. To protect against sales lead fraud, the system has a built-in validation and scrubbing process.

The system can include a customer relationship management (CRM) system and method that links sales cycle functionality to customer relations' management tools, including appointment setting, cross-sell scheduling, triggered event actions (birthdays, business anniversaries, etc.), and outreach (email/text messages) that is scheduled by date/time. Agents can upload and integrate their book of business into the marketing interface.

The system can include a quoting platform and method that automates quote delivery and generation, using enterprise-level quoting data to generate first-impression price proposals and funneling the information directly through the LMS system. This ensures that the quote is as accurate as the information that comes in on the lead. Agents can also set which discounts and IS score to apply. Mass mailing gives agents the ability to produce automated quotes in bulk to streamline outreach to targeted audiences within their customer contact lists. The quoting platform also gives agents the ability to requote old quotes, meaning they can search, reprint, and remail saved quotes. Agents can filter by IFS scores and adjust effective dates to account for an early signing discount. Since this happens in a single marketing interface, agents can search their existing book of business to identify cross-sell opportunities.

The system can include an integrated contact platform that identifies the best engagement channel for each sales lead in real time. For sales leads that are unavailable during the first outreach attempt, they are funneled into a follow-up queue and linked to the interface's CRM system. The contact platform interfaces with non-agent IVR systems, allowing for warm transfers and appointments, meaning they are transferred to agent's dedicated lines or schedule appointments based on agent availability. The system can also include a calendar and reminder system, which may be hosted in the contact platform, ensuring that agents' workflow is centralized in a single calendar that can sync with many other common third-party calendar systems.

In some implementations, the system can include an email marketing system allows sales agents to engage customers based on their interests and engagement channels. Email outreach can be set up as automated one-time, ongoing, or triggered campaigns. AB testing and customer tracking also provides granular data that enables agents to segment their outreach strategies.

The system includes a mobile integration system and method that integrates with agents' mobile devices, such as mobile phones, tablet computers, or the like. For example, the system's calendar and various dashboards can send alerts and push notifications to agents' mobile devices. When consumers click hyperlinks and buttons on their mobile devices, dialing outbound calls from their mobile phones, these calls are routed directly to the agent's mobile device. Location services and mapping tools show agents the existing and potential clients that are in their vicinity. The address and range can be adjusted manually, or set automatically.

The system integrates with any of a number of third party or proprietary social media applications to help agents identify and engage new customers. Within the interface, agents can see the contacts and friends they share with sales leads. Consumers can use their personal social media account credentials to auto fill forms sent to agents. Agents can also set up social media referral campaigns to drive new sales leads via current customers sharing with their networks. The system also performs a content scrape, based on numerous manual or preset filters, to collect a list of suggested contacts as potential customers.

In some implementations, the system provides cross-functional gamification to promote agents' professional development and sales performance. Regional, state, and national benchmarks show agents where they rank among their peers. As system users optimize their actions and/or improve their sales performance, they receive points that are tied to regional, state, and national loyalty programs and rewards. Agents can also assemble their own teams among fellow agents to compare performance among preferred peers.

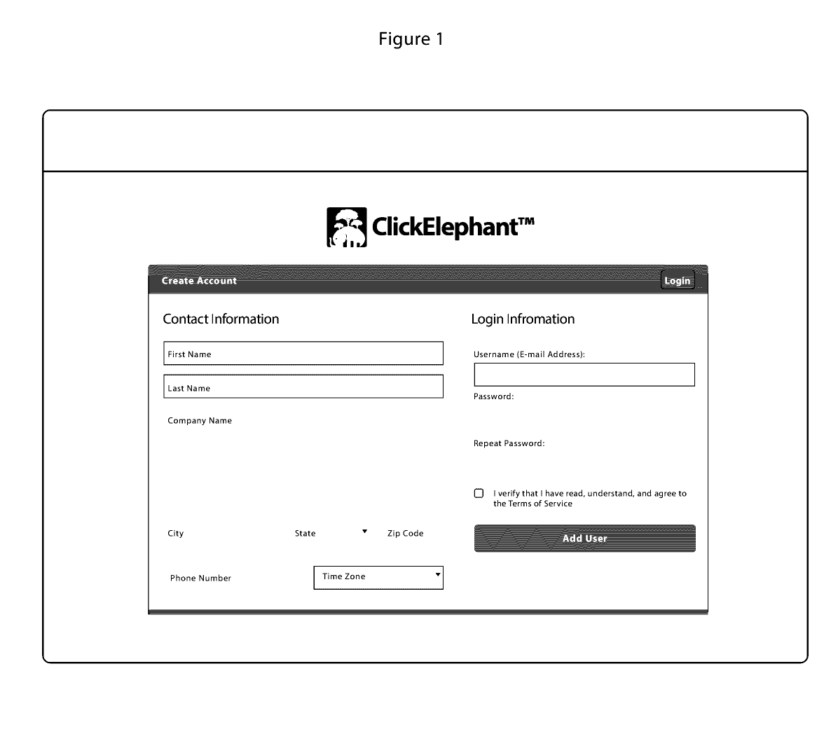

FIGS. 1-16 depict various graphical user interfaces generated by the system to interact with a user for creating, managing and fulfilling sales lead orders. FIG. 1 depicts the graphical user interface used by prospective buyers to apply for access to purchase sales leads. Displayed is a configurable set of profile questions about the buyer that will be used by the sales lead vendor to approve/deny the application.

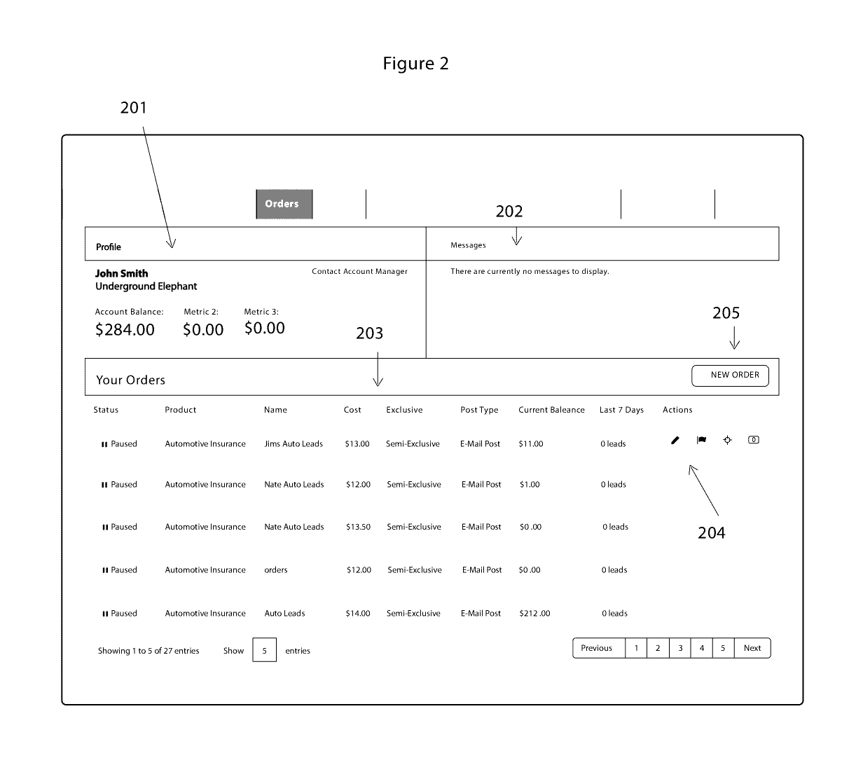

FIG. 2 depicts a graphical user interface used by buyers to quickly view the status of their account and orders. Through the interface, buyers can view their account balance and metrics they define 201, view system generated alerts and customer service messages 202, and view status and descriptive statistics for orders 203. In addition, they can access the edit, filter, target geography, and funding options for existing orders 204. In some variations buyers can choose to create a new order 205.

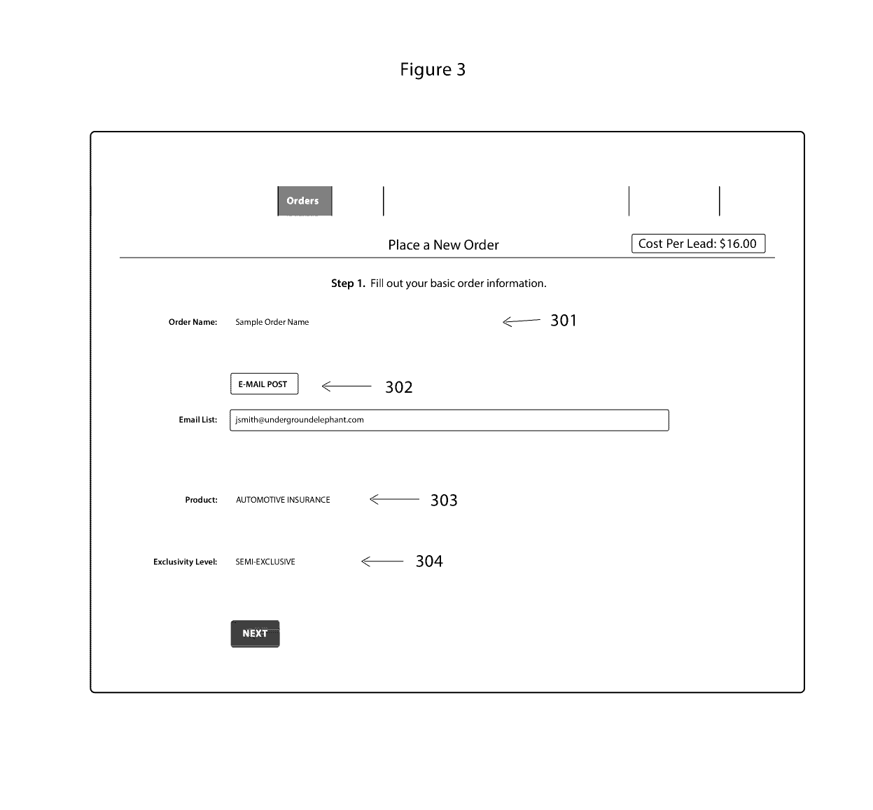

FIG. 3 depicts a graphical user interface used at the beginning of the new order creation process. Through the interface, buyers can specify an order name 301, delivery method for purchased sales leads 302, the type of sales lead 303, the exclusive level for leads 304, and price per leads based on options selected. In this implementation, deliver methods include email, direct post into customer relationship management systems, lead prosecution systems and dialing applications.

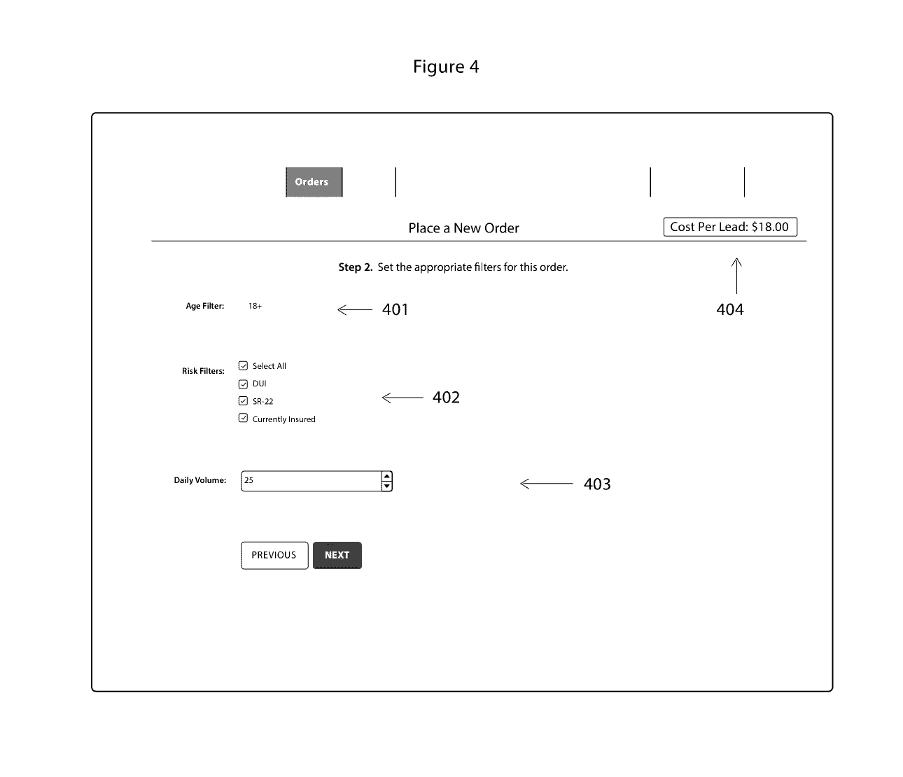

FIG. 4 depicts a graphical user interface for Step 2 of the new order creation process. Through this interface, buyers specify the properties of leads that they would like to purchase. The properties vary by lead type. In this implementation, buyers specify the desired age range 401, exclude leads based on risk factors 402, and set the maximum number of leads that they would like each day 403. The system calculates and displays updated pricing 404 with the selection of each profile element. System administrators configure pricing for individual profile elements as well as bundles of elements by buyer, buyer type, and buyer's parent company/affiliated organization.

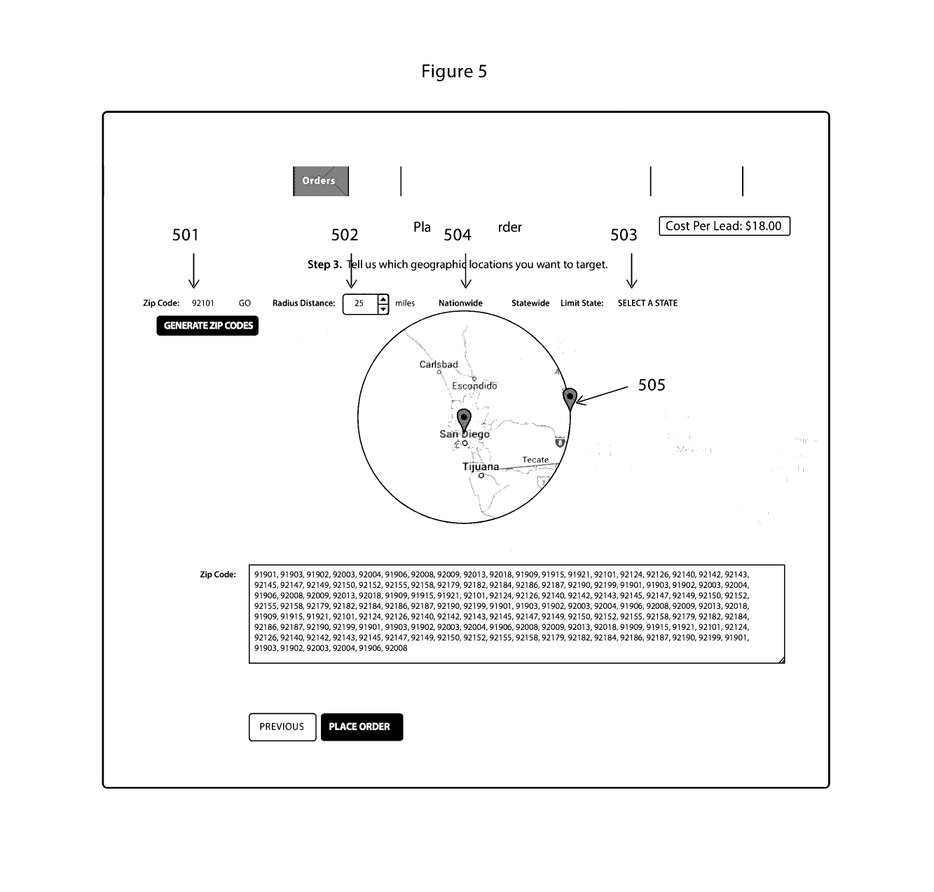

FIG. 5 depicts a graphical user interface used to select the geographic location of sales leads. Through the interface, buyer can specify acceptable locations by zip codes 501, zip codes within a selected region around a base zip code 502, entire states 503, and nationwide 504. Users may adjust the radius through either the input box 502 and/or dragging the circle on the map 505. Administrators can specify whether or not to include sales leads from states outside of the base zip code state.

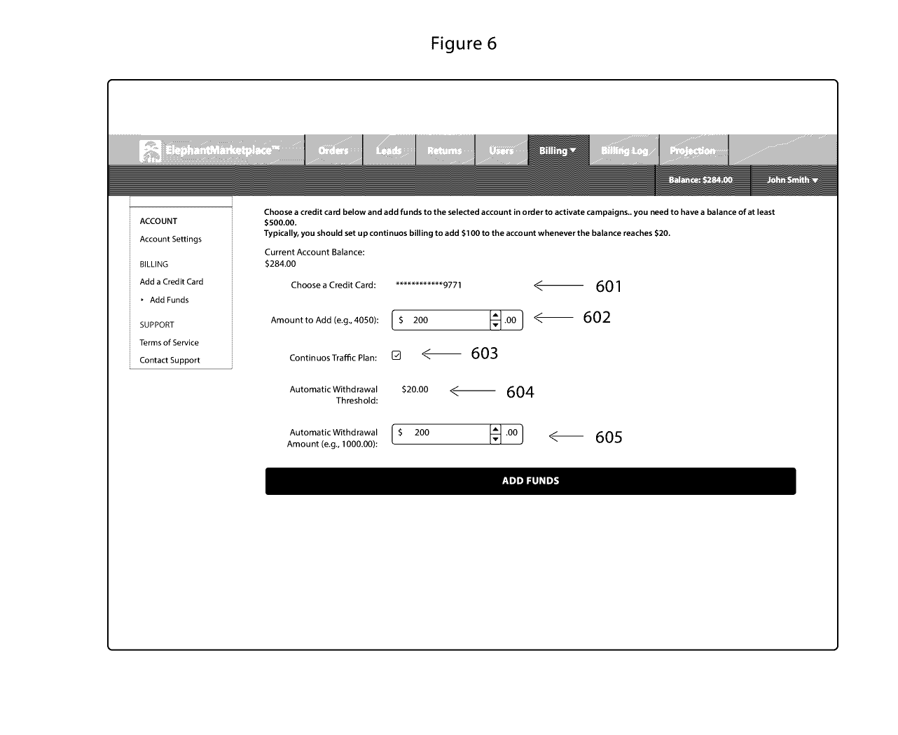

FIG. 6 depicts a graphical user interface used by buyers to fund their account. The system allows for funding at both the account and order level. In this implementation, orders draw funds from accounts. Accounts are funded via credit card. Through the interface, buyers can choose to use an existing credit card or add a new one 601, designate the funding amount 602, enable automatic funding 603 when the account balance dips below a threshold 604, and enter an amount for automatic funding transactions 605. Administrators can specify the funding threshold below which the system will automatically pause the all orders associated with the account. This value can be a negative number. The system can send transaction confirmation and balance alert emails based on administrator configurations.

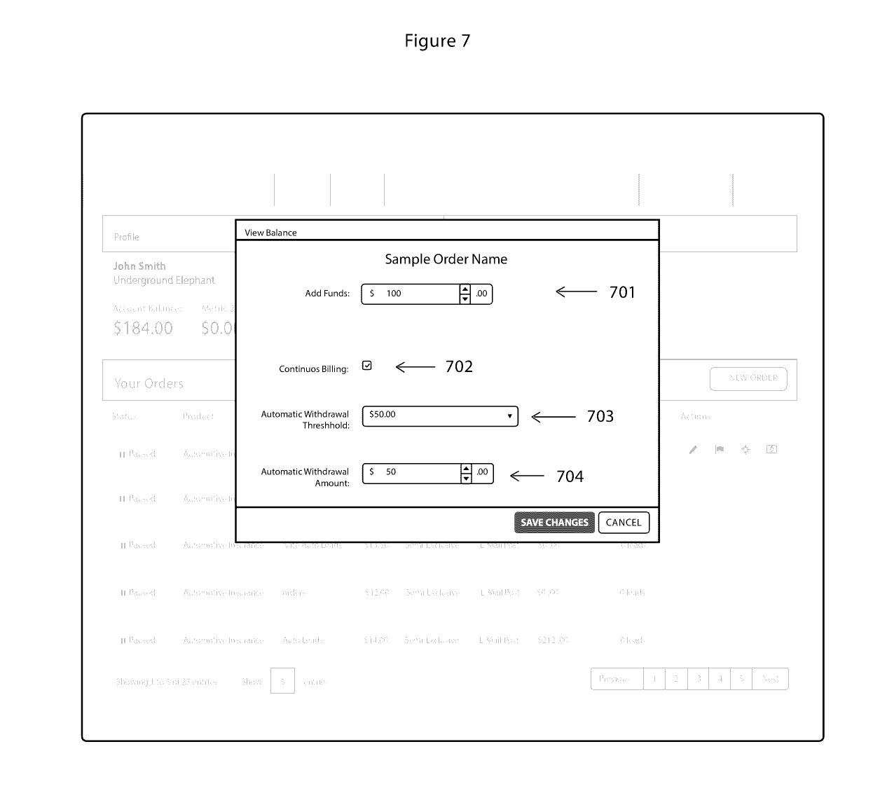

FIG. 7 depicts a graphical user interface that can be used to fund an order, in accordance with some implementations. In a particular implementation, orders draw funds from the buyer's primary system account. Through the interface, buyers designate the funding amount 701, enable automatic funding 702 when the account balance dips below a threshold 703, and enter an amount for automatic funding transactions 704. Administrators can specify the funding threshold below which the system will automatically pause the order. This value can be a negative number.

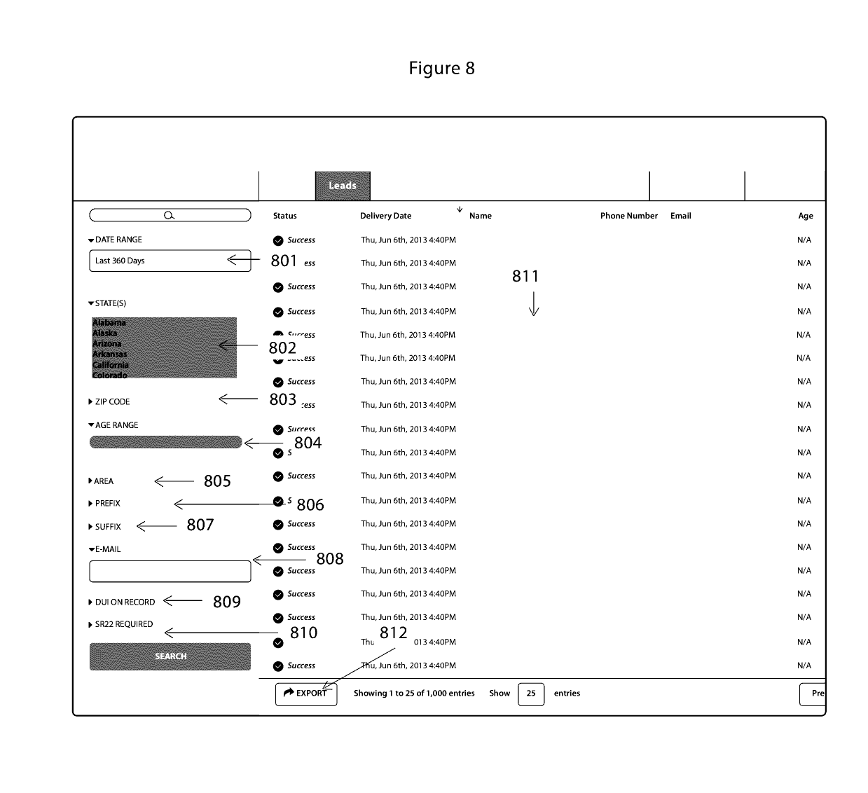

FIG. 8 depicts a graphical user interface used by buyers to view and manage leads purchased. Through the interface, buyers can filter leads based on criteria specific to the associated lead type. In this implementation, buyers can filter automobile insurance leads based on date purchased 801, state 802, zip code 803, age range 804, area code 805, phone number prefix 806, phone number suffix 807, email 808, driving record 809, and required filings 810. Once the filters are specified, the system will display a set of leads 811 and allow the buyer to export the set 812 as a text file.

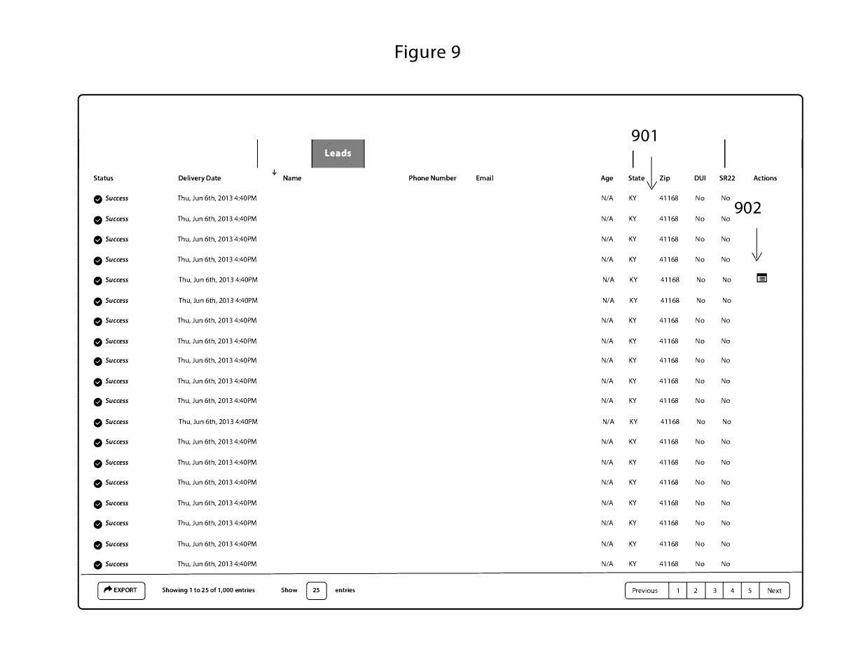

FIG. 9 depicts a graphical user interface illustrated in FIG. 8 after the filter menu collapsed. Collapsing the menu exposes more details about the lead 901 as well as action buttons 902. The action buttons allow buyers to view lead details as well as request authorization to return the lead. System administrators can use fixed quantity and percentage of sales to set thresholds for automatic return authorization by account and/or order. Return requests above the threshold are queued for review by lead vendors. The system automatically sends disposition emails for each lead acted on by a lead vendor. The filter menu can be accessed by selecting the expand arrow.

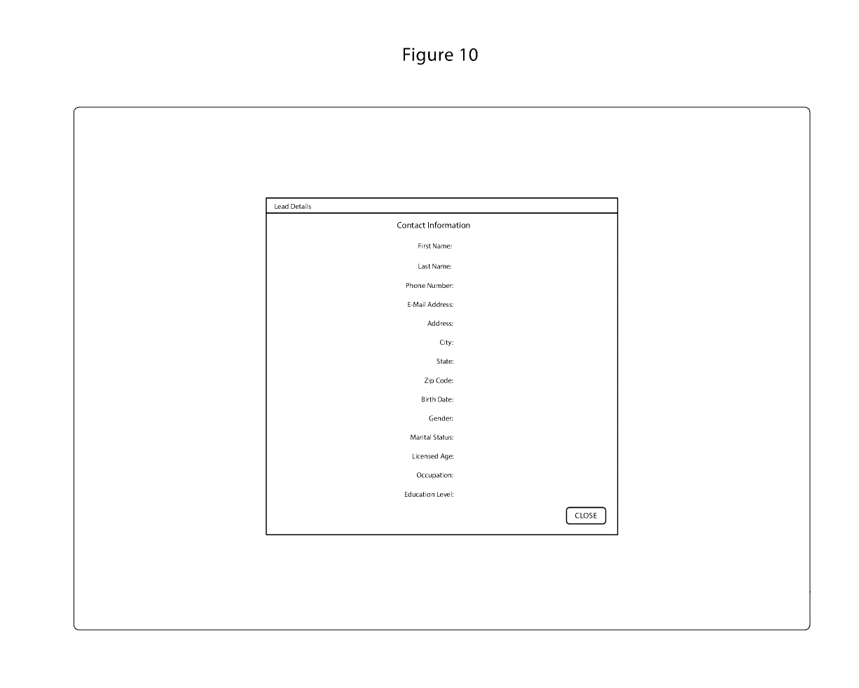

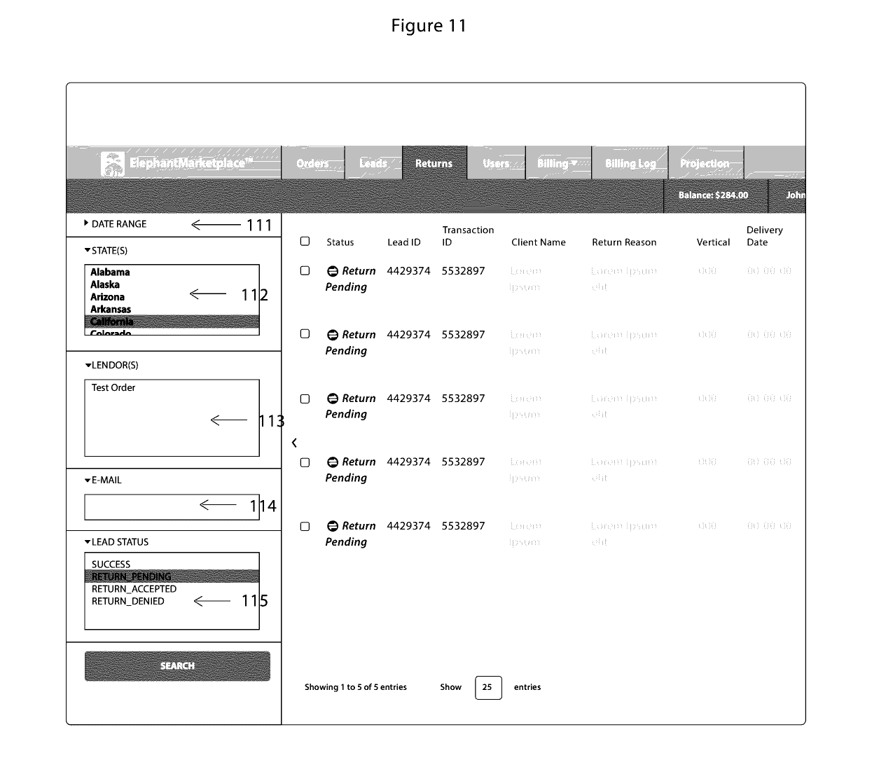

FIG. 10 depicts a graphical user interface used to view detailed lead information when the Lead Details action button is used in FIG. 9. FIG. 11 depicts a graphical user interface used by lead vendors to act on lead return requests. Through the interface, lead vendors can display leads based on filters. Filters vary by lead type. In this implementation, leads can be filtered by return request date 111, state 112, order name 113, buyer email 114, and lead status 115.

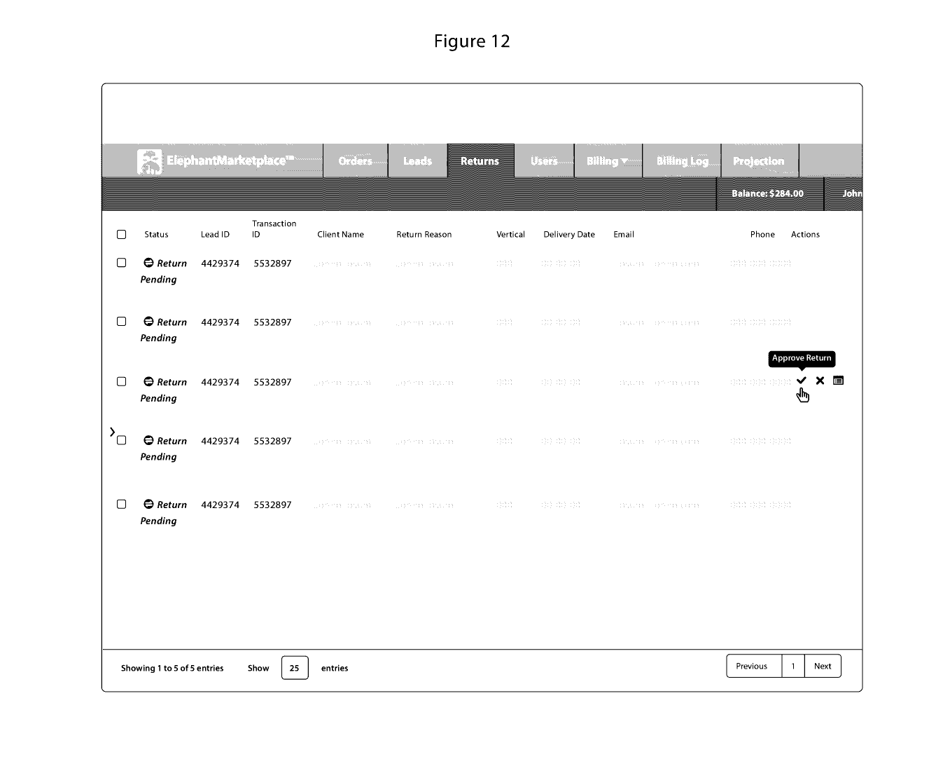

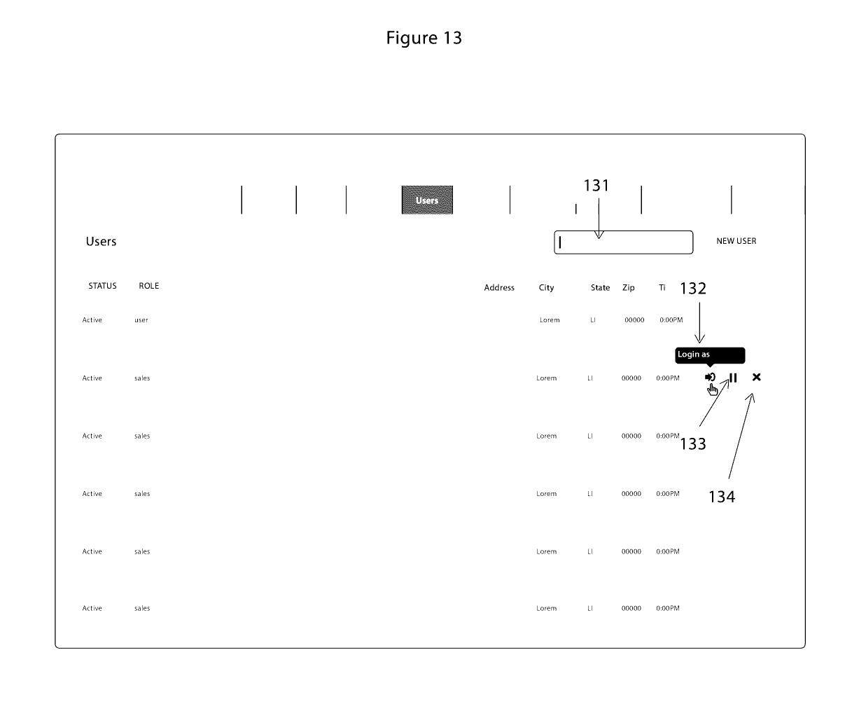

FIG. 12 depicts a graphical user interface from FIG. 11 with the filter menu collapsed. Through this interface, lead vendors can view details about leads as well as approve or deny return requests. FIG. 13 depicts a graphical user interface used lead vendors to manage system users. Through the interface, lead vendors can search for specific users 131, log into the system as a user 132, deactivate a user 133 and delete a user 134.

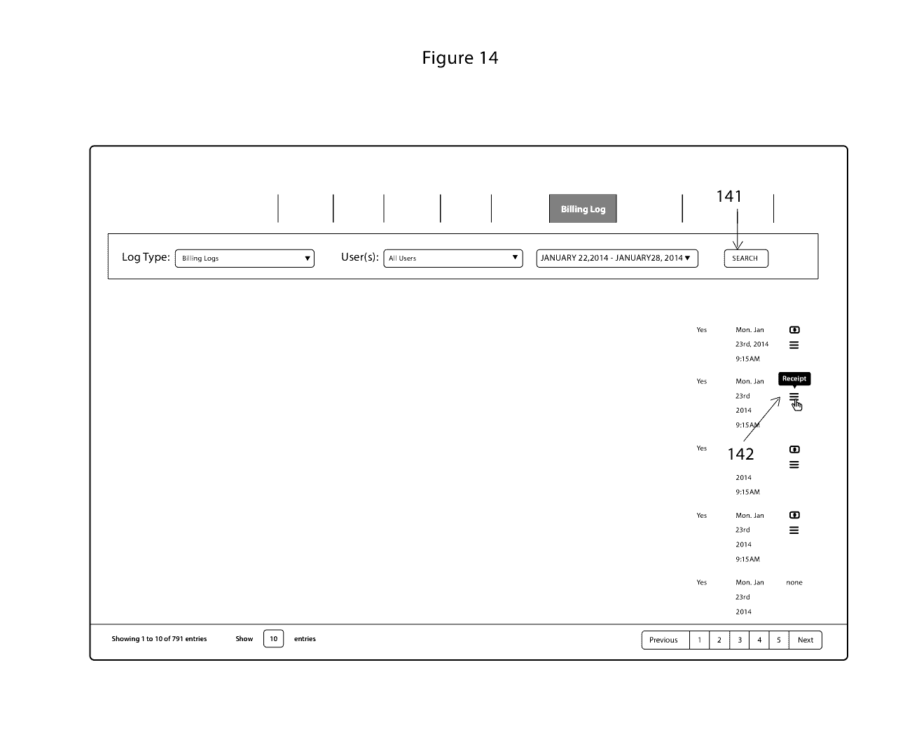

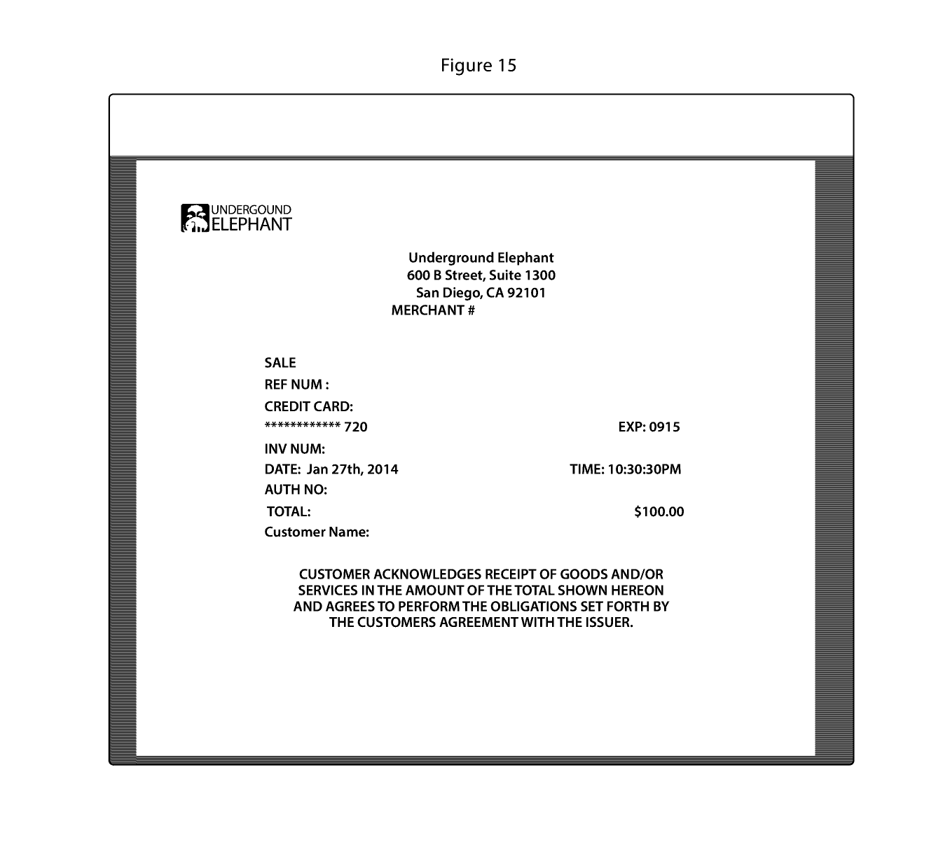

FIG. 14 depicts a graphical user interface used by lead vendors to view and manage billing transactions. Through the interface, lead vendors can locate using filters 141 and view specifics about every billing transaction. Receipts 142 can be generated in PDF form. FIG. 15 depicts an example of a receipt created through the interface depicted in FIG. 14.

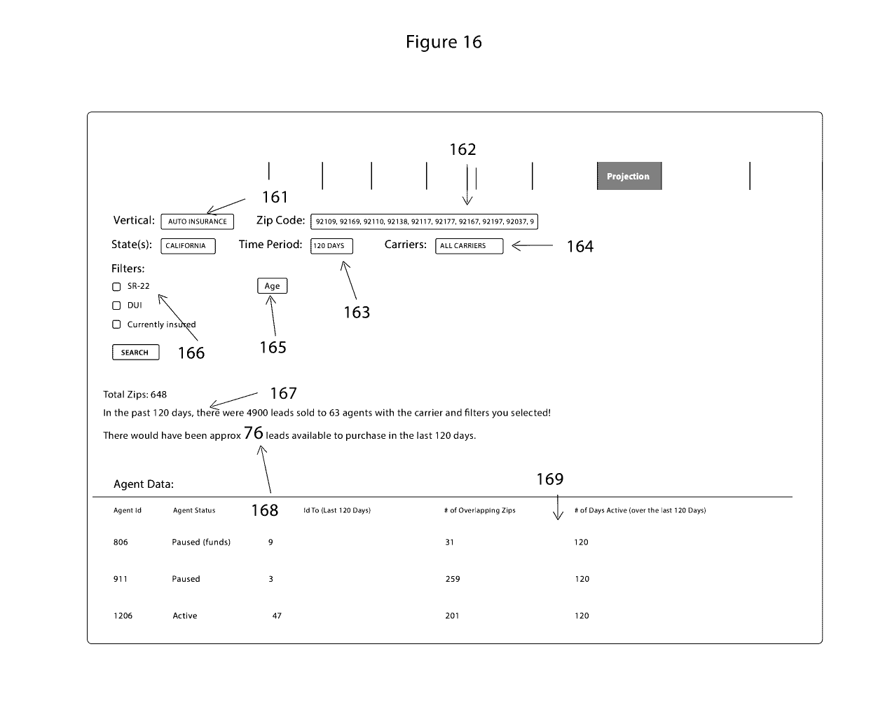

FIG. 16 depicts a graphical user interface used by lead buyers and lead vendors to view leads previously made available for sale through the system. Through the interface, users can input criteria specific to lead types in order to get descriptive statistics about historic lead volume. In this implementation, auto insurance leads 161 can be filtered by geography 162, date generated 163, insurance carrier 164, age 165, and risk factors 166. Descriptive statistics provided cover overall lead volume based on the filters specified 167 as well as how many leads a new agent would have received during the selected period 168. The interface can display orders 169 from other buyers that would have competed for leads with a new buyer.

The system optimizes revenue per lead for the lead vendor by selling to the highest bidding eligible order. Orders that have reached their daily maximum allocation or are inactive are not eligible. If two orders have the same winning bids, the system will distribute available leads in equal portions and in circular order.

Lead vendors can specify rules that automatically remove leads from inventory prior to being sold. Data used by the rules can come from the lead itself as well as data values and quality scores from third-party sources. Common examples of leads that are removed involve those with a consumer name (such as “Mickey Mouse” for example) and duplicates. Lead vendors can specify the maximum number of times that a non-exclusive lead can be sold. Lead vendors can modify leads and add them to available inventory.

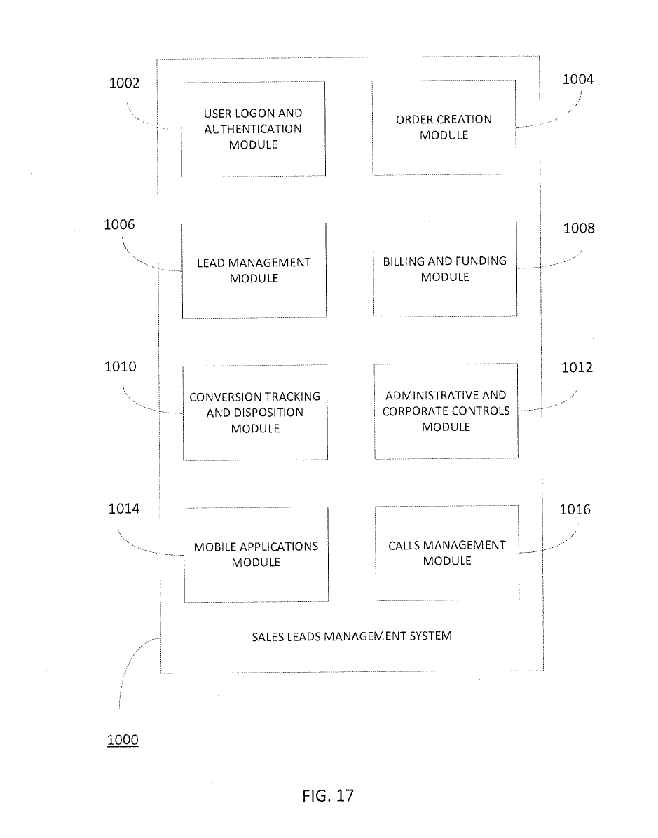

FIG. 17 is a functional block diagram of a system 1000 for creating, managing and fulfilling sales lead orders. The system 1000 includes a user logon and authentication module 1000 that provides a user management tool that supports standard user functions such as login, user registration password and reset. In some implementations, the user logon and authentication module 1000 allows users to be organized in a hierarchy, so that authentication rules can be applied to different groups of users. Every application component, page, and feature can be independently secured. The user logon and authentication module 1000 is an administrative function that lets a system administrator change any user's settings, and login as any user.

The system 1000 system can include an order creation module 1004 to create and manage lead orders, a lead management module 1006 to manage leads from lead vendors as well as various interactive tools for viewing lead actions, and a billing and funding module 1008 to manage financial transactions occurring on the system 1000. The functionality of each of these integrated modules is discussed in further detail below. The system 1000 can include a conversion tracking and disposition data module 1010, an administrative and corporate controls module 1012, a mobile applications module 1014, and a calls management module 1016, which are also described in further detail below.

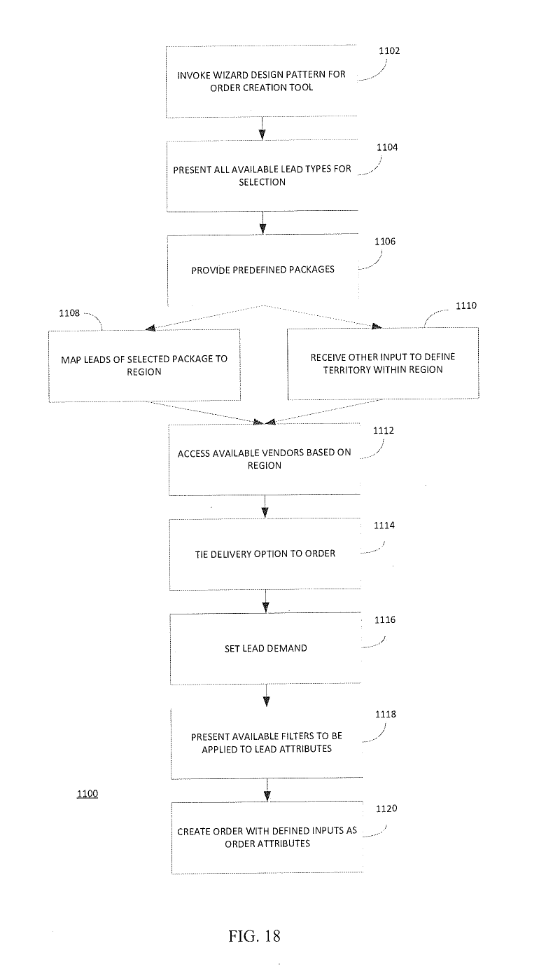

FIG. 18 illustrates a process 1100 executed by the order creation module 1004, in accordance with some implementations. At 1102, a wizard design pattern is invoked by the order creation module 1004, to guide the user through the process 1100 for creating a lead order. At 1104, the order creation module 1004 presents all available lead types for selection 1104. The presentation can be in a graphical user interface or other visual display, such as one or more of the graphical user interfaces described above. At 1106, the order creation module 1004 provides predefined packages of leads for selection. The packages contain presets for all available order options. The selected package is sent to the order creation module 1004, and the associated settings are selected.

At 1108, leads are mapped to a region, or at 1110 other input is received to define a territory within a region. For instance, the wizard displays an easy to use map interface. The interface takes a zip code and radius as input. The map displays the area selected, with the defined radius highlighted. The actual postal codes are displayed, and the system can select/deselect particular postal codes. Alternatively, or in addition, the map is also designed to take other types of input. e.g., a state/province can be passed as input to have that area highlighted and selected (on the backend, all zip codes in the province will be accessed). The system can also use defined “territories,” or groups of postal codes.

At 1112, available vendors are accessed based on the region. The order creation module 1004 takes a geographical area as a set of postal codes as input, and hooks into available vendors. This data is presented as a list of vendors, along with volume projections in the given area. A vendor is selected as input. At 1114, delivery options are associated with an order. The system 1000 is integrated with several delivery methods (e.g., email, CRM post, etc.). The order creation module 1004 allows one or all options to be tied to the order. There is also an option to be notified via SMS when a new lead is received by the system 1000. At 1116, lead demand can be established. The order creation module 1004 takes daily, weekly, and monthly values as input in order to set the lead demand of the order (caps), and can also take a dayparting schedule as an input, so that leads are only delivered during a given time frame (time of day and/or day of week).

At 1118, available filters to be applied to lead attributes are presented. The order creation module 1004 presents available filters to be applied to lead attributes, and takes filter sets and values as input, and assigns them to the order. Finally, at 1120, the order creation module 1004 creates the order with all of the defined inputs as order attributes. The system 1000 displays all orders on the order screen, where they can be activated, paused, and edited. An “edit order” function uses a similar feature as for order creation, but edits an existing order rather than creating a new one. When an order is paused, the system 1000 can take a reactivation date as input, and the order will automatically be activated on that date.

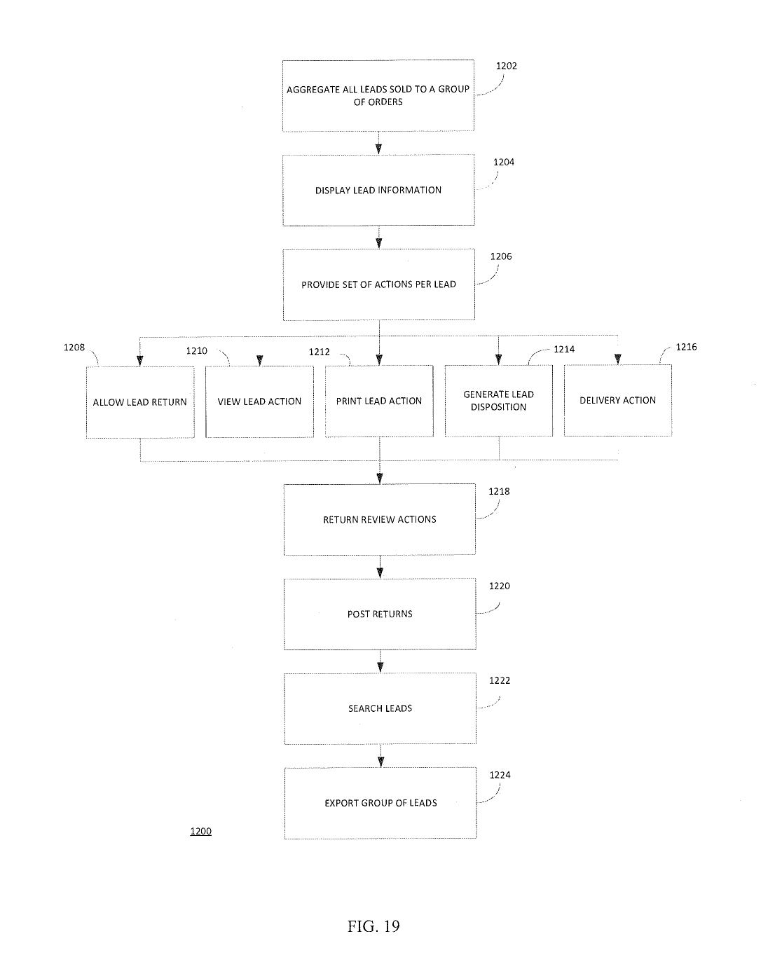

FIG. 19 illustrates a process 1200 executed by the lead management module 1006, in accordance with some implementations. At 1202, the lead management module 1006 aggregates all leads sold to a group of orders. These orders might be associated with a user, or a group of users. At 1204, the lead management module 1006 displays lead information, such as PII, lead status, and the associated order, user, and/or group.

At 1206, a set of actions for every lead is provided by the lead management module 1006. These actions can be displayed in a drop down menu, or as a set of graphical control buttons, etc. The actions include, without limitation, an ability to have a lead returned, at 1208. This action sends the lead to the lead's vendor along with a return reason that is selected from a group of predefined reasons. The lead status is also changed. Another action, at 1210, is a “view lead” action, in which all lead details are displayed and made viewable to a user. At 1212, lead details can be printed, based on the user interface of the lead management module 1006. At 1214, another action of the lead management module 1006 is a “disposition” action, where the lead management module 1006 can take a new status as input: contacted, returned, closed, left voicemail, etc. At 1216, a delivery action allows a lead to be redelivered to the order-defined delivery channels, as described above.

At 1218, the lead management module 1006 provides return review actions to lead vendors, who can view, approve, or deny lead return requests. Vendors deny returns by selecting a deny reason from a list of predefined reasons provided by the system 1000. The lead management module 1006 also provides an API for return reviews to be posted programmatically, at 1220. The lead, review status, and deny reasons can all be posted and updated in the system 1000. At 1222, the lead management module 1006 provides a search function which can show a subset of leads based on a search input, whereby any attribute of the lead can be searched. Finally, at 1224, the lead management module 1006 provides an export function that allows a group of leads to be exported from the system 1000 to any third party computing platform.

The billing and funding module 1008 provides an interface to enter credit card or other financial transaction tool information. Multiple account numbers can be added and managed. The account information is passed to an offline merchant account, and a corresponding identifier is stored in the system 1000, such that no account information is stored on the system 1000 server(s). The billing and funding module 1008 can be used to add funds from any available account. The billing and funding module 1008 provides an optional continuous billing component, which automatically withdraws funds from a selected account when a balance for the associated customer is below a target or predetermined threshold. The billing and funding module 1008 also provides a log of all transactions, and provides various options to view and print reports.

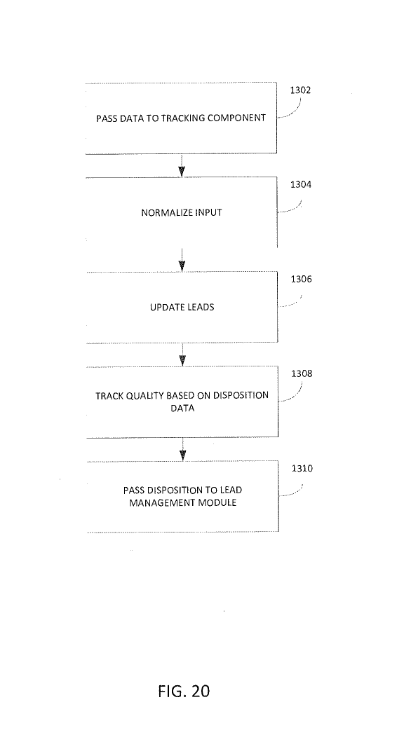

FIG. 20 illustrates a process 1300 executed by the conversion tracking and disposition data module 1010, in accordance with some implementations. At 1302, data is passed to the conversion tracking and disposition data module 1010 via an API or by user input. At 1304, the input is normalized and matched with lead data. At 1306, matched leads are updated with information in the input data. At 1308, the conversion tracking and disposition data module 1010 tracks quality of the leads by source, agent, and other metrics, based on disposition data for each lead. The conversion tracking and disposition data module 1010 tracks the disposition of each lead through the process, and generates the disposition data. At 1310, the conversion tracking and disposition data module 1010 passes the disposition data and quality data to the lead management module 1006. This data can also be used by the system 1000 for reports and vendor rankings.

The administrative and corporate controls module 1012 provides platform-wide reports on lead volume and/or quality, user interaction, etc. The system 1000 employs the administrative and corporate controls module 1012 as a way to view user information, and to allow login as any user. The administrative and corporate controls module 1012 can provide a dashboard or other user interface, to change user settings and turn user access on or off.

The mobile applications module 1014 provides access to the system 1000 by any of a number of mobile applications that are available for any mobile operating system. In preferred implementations, the mobile applications are implemented as web-based functionality. Preferably, each application can send the user “push” notification, such as native notifications that occur outside of the application. Such notifications can alert a user, using the application on an associated mobile device, when a new lead arrives to the system 1000. The mobile application can then automatically call an incoming lead, and connect the user with the lead. The mobile application can also utilize location services of the mobile device to match leads to a dynamic location of the user. The functions and activities conducted with the mobile application are tracked, processed and at least partially stored by the system 1000.

The calls management module 1014 provides an online and integrated platform to buy and sell live calls. The calls management module 1014 includes an interface to receive a destination phone or pool of phone numbers to which live calls can be transferred. The calls management module 1014 can include a management interface that provides a way for calls to be turned on/off, and also set on a schedule. A map interface can be included to graphically specify an area from which to receive calls. The calls management module 1014 also handles leads, so that call-verified leads can flow through the system 1000.

The calls management module 1014 includes a calls API to allow a call publisher to offer a live (i.e. real-time) transfer. If there is a matching order, the calls management module 1014 will respond to the publisher with a bid price and destination phone number. The publisher then transfers the call, while also posting the lead data to the calls API. Accordingly, the call can be sold as a transfer, and/or the lead is sold as a call-verified lead.

The present disclosure relates to facilitating and managing the providing of sales lead information from a lead source to a lead client/buyer. Such facilitation and management may be performed by a lead management system. In some implementations, a lead management system may receive sales leads from sales lead sources. The lead source may include webforms. In some implementations, the webforms may be provided by the lead management system operator. The sales lead information may be validated by the lead management system. After validating the sales lead information, the sales leads may be scored and matched to potential lead clients/buyers. After being scored and matched sales lead information may be distributed to lead clients/buyers as appropriate.

In some implementations lead information may be received and validated in real time or near real time. In some implementations, validating and/or scoring the lead information may be done to the extent necessary to distribute those leads with the highest propensity to convert. The lead management system may be configured to receive real time sales lead information, historic sales lead information, or other sales lead information.

The lead management system may be configured to process a wide array of business rules provided by lead clients/buyers. The business rules may include highly custom business rules. The lead management system may provide a level of automation to avoid the need for human intervention. The lead management system may be provided with one or more target metrics, such as revenue, profit, lead quality, and/or other target metrics. The lead management system may be configured to automatically maintain the target metrics without human intervention.

The lead management system may be configured to access a lead management database. The lead management database may be configured to store lead sales information, scoring information associated with the sales leads, and/or other information associated with the sales lead information. The lead management system may be configured to manage the lead management database. The lead management system may be configured to augment the lead management database with third party data received by the lead management system. The lead management system may be configured to monitor rules and/or restrictions associated with third party services and/or databases. The lead management system may be configured to handle third party information in accordance with the rules and/or restrictions.

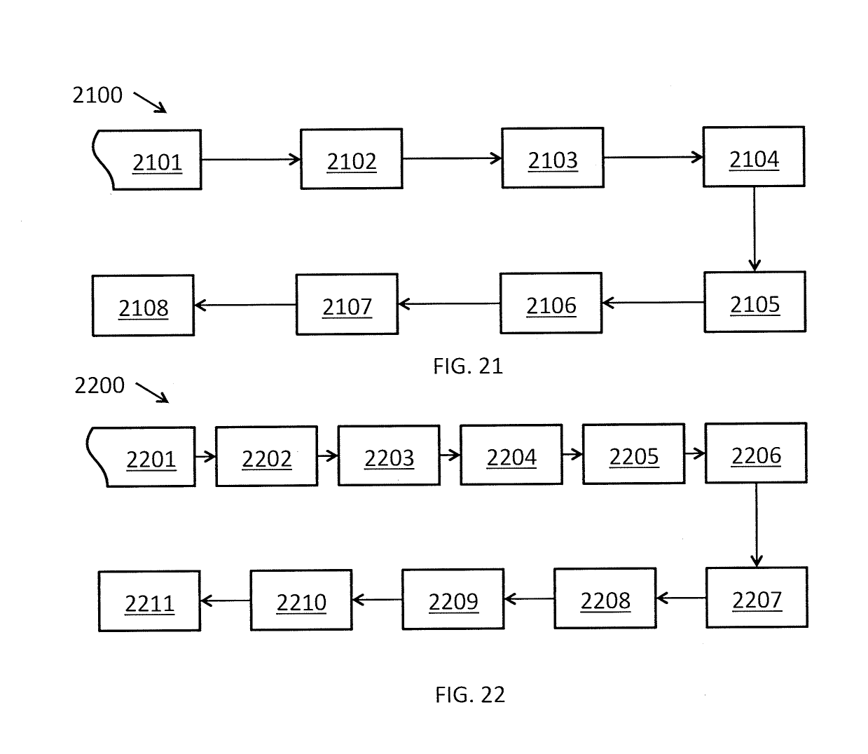

FIG. 21 is a process flow diagram 2100 illustrating aspects of a method having one or more features consistent with implementations of the current subject matter. The operations illustrated in FIG. 21 may be performed by a platform configured to management sales lead information.

At 2101 lead information may be received. A lead may be a consumer having interest or inquiry into products or services of an organization. Lead information may relate to leads created for any purpose. Some purposes may include generating leads for distribution of information. Other purposes may include generating leads for the purposes of selling services or products to individuals or organizations associated with those leads. Organizations strive to generate “quality” leads which are those leads having a higher probability of converting into a desired outcome. The lead information may be received from a lead source. Leads may be received from any source and/or vertical. Sources may include, for example, digital sources, such as through the Internet, personal referrals, lead vendors, call centers, through advertisements, events, and other lead sources. In some variations, leads may be acquired from lead marketplaces such as post or pingpost.

At 2102 at least some of the sales lead information may be validated to generate validated sales lead information. The sales lead information may be validated based on one or more validation rules. The validation rules may be configured to normalize the format and/or identity of the sales lead information.

In some implementations, the one or more validation rules may include cross-referencing at least some of the sales lead information against information provided by a third party to normalize the format and/or identity of the sales lead information. The one or more validation rules may include cross-referencing at least some of the sales lead information against one or more information databases to normalize the format and/or identity of the sales lead information.

In some implementations, the validation rules may audit several data points contained in the sales lead information. The validation rules may be customized. The validation rules may check sales lead information attributes. Such attributes may include the Internet Service Provider (ISP), the Internet Protocol (IP) address, or other electronic information used by the sales lead source, the sales lead, or other parties. Such attributes may include User Agent information which may maintain custom rules or blacklists of certain sales lead sources and/or sales leads. The system may integrate with third party services to validate sales lead information. For example, the third party services may facilitate the validation of addresses, telephone numbers, email addresses and/or other sales lead information. For example, a given street address may or may not match with a given zip code. Third party services may be used to verify such information.

The validation rules may verify that the sales leads and/or the sales lead sources comply with one or more regulations. For example, the validation rules may verify that the sales leads associated with the sales lead information have properly opted in. The validation rules may verify that the sales lead information, the associated sales leads, and the sales lead sources comply with the Telephone Consumer Protection Act (TCPA). The validation rules may remove duplicate entries. One of ordinary skill in the art will understand and appreciate that the validation rules may be added to, or customized, ad infinitum.

In some implementations, the sales lead information may comprise multiple fields. Certain ones of these fields may be so-called “required fields.” These required fields may be validated first by the one or more validation rules. In response to an indication that these required fields fail to meet certain minimum standards or fail certain validation rules a notification may be provided to the sales lead source that the sales lead information provided failed the validation process.

At 2103 sales lead information received from sales lead sources may be augmented. The sales lead information may be augmented using information already obtained that is associated with individual or groups of sales leads. The sales lead information may be augmented using information from third party sources. For example, at least some of the sales lead information associated with a sales lead may be used to obtain additional information about that sales lead. A zip code or IP address may be used to obtain information associated with the geographical location of the sales lead. An email address may be used to identify social profiles associated with the sales lead. Social profile information may include information to augment with the received sales lead information. A phone number or name may be used to find an address, or vice versa. Public databases may be used to determine home ownership information property tax information, professional qualifications and/or other information. A database may be maintained by the recipient of the sales lead information and/or a third party in which to derive information from associated with the sales lead information.

Augmenting the sales lead information may include cleansing the sales lead information. The sales lead information may comprise spelling mistakes. Spelling mistakes may be determined based on reference to common dictionary spellings of certain words. Spelling mistakes may be determined based on consulting one or more databases to determine the likely intended word based on other information provided with the sales lead information. Historical databases may be used to check for obviously bad data, such as the name associated with the sales lead information being “Mickey Mouse” or “Winnie the Pooh.” Any validation system may be used.

In some implementations, throughout the validation at 2102 and augmentation at 103 the status of the sales lead information may be updated. Such statuses may include “valid,” “invalid,” “pending review,” “duplicate,” “DNC,” and/or any other status identifier.

In some implementations, at 2102 or 2103, data may be validated and/or augmented by sending the sales lead information to a third-party service. The third-party service may respond with a score for the accuracy of the information and may include additional information associated with the sales lead information. For example, secondary telephone numbers, secondary addresses, correct addresses, current/previously aliases and/or other information may be provided by a third-party service.

At 2104 triggers may be configured and associated with individual sales leads. Triggers may be configured to perform actions associated with sales leads. Such actions may include whether to permit autodialing, sending of SMS messages, sending of email messages and/or other actions. The validation rules may be used to control the triggers that area bound to each sales lead.

At 2105 a score may be generated, by one or more physical processors, for each of the validated sales lead information. The score may be generated according to a scoring algorithm executed by the at least one data processor. The scoring algorithm may include calculating the score based on one or more attributes of the validated sales lead information.

Generating a score may include generating a score associated with at least some of the validated sales lead information for a given buyer of sales lead information. In some implementations sales leads may be routed for delivery to a buyer. The sales lead information may be matched to the right buyers based on generating a score associated with the sales lead information for that buyer. The scoring algorithm may be configured to maximize the return on investment for the buyer of sales lead information, the seller of sales lead information, and/or both the buyer and seller of sales lead information. In some implementations, the scoring algorithm may be configured to generate an overall score for the sales lead information. The scoring algorithm may be configured to generate a plurality of individual scores for the sales lead information as it applies to a plurality of individual buyers of sales lead information.

At 2106 buyer information may be received by the one or more physical processors. The buyer information may relate to buyers of sales lead information. Buyer information may include geolocation, consumer data, potential product type and/or other information type. In some implementations, at 2106 buyer information may be generated for sets of sales lead information. In some implementations, at 2106 buyers may be filtered for the received sales lead information. The received sales lead information may include one or more attributes. The one or more attributes may provide an indication as to appropriate buyers for that particular sales lead information. The attributes may be used by the one or more processors to facilitate the generation of one or more buyer filters. The one or more buyer filters may be applied to the buyer information and filter the buyers to ones that are most appropriate for the sales lead information.

Buyer information may be filtered to optimize sales lead quality, buyer return on investment, sales lead generators, or a combination thereof. A buyer's return on investment may be determined based on the cost to acquire the sales lead, the media costs in acquiring the sales lead, potential revenues from the sales lead, historical performance of the buyer and/or similar sales leads.

At 2106, in response to validating the sales lead information at 102 and generating a score for the validated sales lead information that is in excess of a minimum threshold at 105, a client for the validated sales lead information may be determined. In some implementations, the client may be notified of the sales lead information. The sales lead information may be accompanied with a level of validity and/or the score determined at 105 for the sales lead information. A bid price may be electronically offered by the client to the sales lead source. The bid price may be communicated to the sales lead source. In response to the sales lead source accepting the bid price offered by the client, the validated sales lead information may be provided to the client at 2107.

The sales lead information provided to the client prior to acceptance of the bid price by the sales lead source may comprise partial sales lead information. The sales lead information provided to the client in response to receiving an acceptance of the bid price from the sales lead source may include an increased amount of sales lead information.

At 2105 and/or 2106, the sales lead information may be examined and matched to prospective buyers. The matching may be done in accordance with one or more buyer filters. The one or more buyer filters may be buyer-provided filters giving indications of the types of sales lead information that the buyer wishes to receive. Additionally, the one or more buyer filters may be lead management system—provided filters corresponding to features paid for by buyers. At 2105 and/or 2106, a pool of potential buyers may be determined by matching the sales lead information with the buyers. Sales lead information and/or buyer information, including buyer filters, may be examined to find an optimal match. The sales lead information and/or buyer information may be examined according to a matching algorithm.

The matching algorithm may factor in one or more matching variables. The one or more matching variables may include revenue, cost, lead source, quality, buyer provided data, historical data, offline data and/or other data. The one or more matching variables may include variables associated with data received from buyers in response to receiving prior sales lead information.

Lead scores may be based on parameters. The parameters may be selected as being parameters most relevant to client needs. In some variations, parameters may be selected based on their relevance to a client's business needs. In other variations, parameters may weighted based on their relevance to a client's business needs. Adjustments may be made to the parameters depending on the specified required demographics for the sales leads. Adjusting the parameters in this manner facilitates providing clients with qualified sales leads in a timelier manner.

At 2107, a representation of validated sales leads may be generated for delivery to a client, or buyer. The representation of validated sales lead information may be based on the validated sales lead information having a score above a minimum threshold. The minimum threshold may be a predetermined minimum threshold. The minimum threshold may be based on the sales lead information, the generates scores for the sales leads, the generated scores for the clients/buyers, and/or other information. In some implementations the minimum threshold for the generated score for a particular client/buyer may be dynamic. The minimum threshold may dynamically change based on any of the foregoing factors and/or other factors.

Leads may be delivered to a client/buyer in any manner. For example, leads may be delivered to the client by third-party lead generation platforms, Email, File Transfer Protocol (push or pull), and/or other methods of delivery. A client may select the desired methods and/or formats of delivery of the sales lead information.

At 2108, clients/buyers may provide sales lead performance data. The sales lead performance data may provide an indication of the performance of the sales leads delivered to the clients/buyers. The sales lead performance data may be used during the operations at 2105 to facilitate scoring of the validated sales lead information. Subsequently to the clients/buyers providing the sales lead performance data, the sales lead performance data may be normalized to comply with the format used by the operations at 2105. In some implementations, the normalized sales lead performance data may be merged with the originally received sales lead information.

In some implementations, generating a score of the validated sales lead information at 2105 includes generating a score for the validated sales lead information based on the received sales information.

In some implementations, sales lead information received from the sales lead sources may be tracked. Tracking of the sales lead information from a sales lead source may eventually provide an indication of the effectiveness of the sales lead source. In some implementations, at 2102, a level of validity of the sales lead information may be determined. The level of validity of the sales lead information may be communicated to the sales lead source that provided the sales lead information.

In some implementations, a payment for the sales lead source may be determined. The amount of the payment for the sales lead information may be determined based on the level of validity of the sales lead information. In some implementations the amount of the payment for the sales lead information may be determined based on the sales lead performance information received from the client/buyer.

In some implementations, a platform may be provided that includes a mechanism to create a new lead source. New lead sources may be created, for example, one a web page and/or by a web page owner. A record of the new lead source may be stored as a lead source for receiving sales lead information. Payment information associated with the new lead source may be provided and stored. The presently disclosed platform may generate an integration specification detailing how sales lead information data should be submitted to the platform. In some implementations, the lead source may comply with the integration specification. In other implementations, the platform may normalize the data provided by the lead source to make it comply with the integration specification. This integration specification may be provided for integrations of data from existing lead sources as well as new lead sources.

An integration system that facilitates normalizing the data in accordance with the integration specification may be executed and/or installed on third-party lead management platforms, client relationship management platforms, on a web page, in a call-center and/or other third party locations. In some implementations, the presently disclosed platform may create a specification-compliant web form for the lead source to use.

Sales lead information submitted by a given sales lead source may be attributed, by the platform, to that given sales lead source. This allows for tracking of the sales lead information submitted by individual sales lead sources. Other attributes associated with the sales lead information may be tracked. For example, the sales lead source may have created or may participate in one or more campaigns. The campaign information associated with the sales lead information may be tracked. Other attributes such as traffic source, creative identification, sub-source information and/or other attributes associated with the sales lead information may be tracked.

In some implementations, real-time notifications may be provided by the platform to the sales lead source. Such notifications may indicate the validity of the sales lead, whether the sales lead matched with one or more clients/buyers, whether the sales lead was sold to a client/buyer, the score associated with the sales lead and/or the client/buyer, and/or other metrics associated with the sales lead information.

Analyzing sales lead performance information provided by clients allows the lead management system to capitalize on inquiry applications by utilizing the information to create accurate analyses of conversion data. This analysis may facilitate the identification of specific lead sources, advertisements, webpages, and other sales generation elements that are not converting for clients. Thus the clients are able to focus on the highest-performing sales lead sources.

FIG. 22 is a process flow diagram 2200 illustrating aspects of a method having one or more features consistent with implementations of the current subject matter. The operations illustrated in FIG. 22 may be performed by a platform configured to management sales lead information.

At 2201 partial sales lead information about a sales lead is received by a lead management system platform. The partial sales lead information may be provided by a sales lead source. At 2202 the partial sales lead information may be validated by the lead management system platform using one or more validation rules. At 2203 the partial sales lead information may be scored and/or matched to a buyer of sales lead information. At 2204 a request for a bid for the sales lead information may be sent by the lead management system platform to one or more buyers or clients. At 2205 a bid for the sales lead information associated with the partial sales lead information may be received from a buyer or client by the lead management system platform. Providing partial sales lead information may avoid poaching by potential buyers/clients and/or may provide greater peace-of-mind to the sales lead source.

At 2206, in response to receipt of a bid for the sales lead information, the lead management system platform may notify the sales lead source of a successful response from a buyer/client. The response may include an offer to sell the sales lead information for the bid price provided by the buyer/client. At 2207, in response to an indication of acceptance by the sales lead source to the bid from the buyer/client, the lead management system platform may receive the rest of the sales lead information associated with the accepted bid price. In some variations, the lead management system platform may be configured to pull the information from the sales lead source. In some variations, the lead management system platform may be configured to request the information from the sales lead source. In some variations, the sales lead source may provide, or post, the rest of the sales lead information to the lead management system. In some variations, the sales lead source may provide, or post, the rest of the sales lead information directly to the buyer/client.

At 2208, in response to the rest of the information being provided to the lead management system platform, the lead management system platform may validate the full sales lead information according to one or more validation rules. In some implementations, at 2209, the lead source management system platform may augment the full sales lead information with previously obtained information and/or third party provided information.

At 2210, in response to the full sales lead information being determined to be valid, it may be provided to the buyer/client. At 2211 the sales lead source may be notified of the successful purchase and transfer of the sales lead information to the buyer/client. In some implementations, the notification may be through email, a webhook, a message and/or any other communication medium.

Should the transactions between the sales lead source and the lead management system platform, the sales lead source and the buyer/client, and/or the lead management system platform and the buyer/client fail at any time, the lead management system platform may be configured to cause a notification to be sent to the sales lead source providing an indication of the failure of the transaction.

In this manner, the lead management system platform may provide a digital lead auction for sales leads. The delivery of the sales lead information may be determined by the buyers and/or sellers.

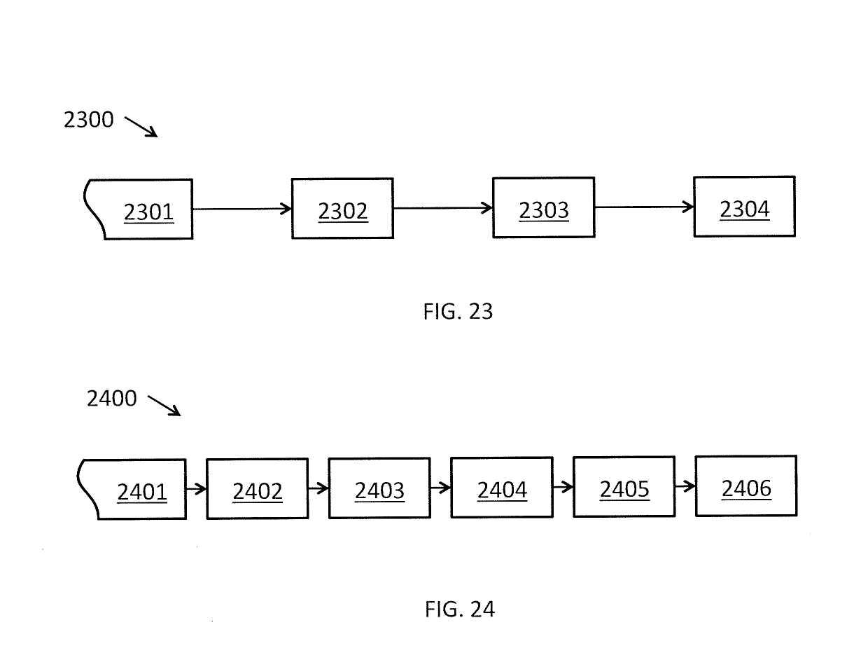

FIG. 23 is a process flow diagram 2300 illustrating aspects of a method having one or more features consistent with implementations of the current subject matter. The operations illustrated in FIG. 23 may be performed by a platform configured to management sales lead information.

At 2301, the lead management system platform may provide an email account for a sales lead source. The email account may be configured to receive submissions of sales lead sources by the sales lead source. The email account may be controlled by the lead management system platform. At 2302, the sales lead source may submit an email to the provided email account containing at least some sales lead information. At 2303, the lead management system may be configured to parse text from the email body received from the sales lead source. At 2304, a determination may be made as to whether the text format parsed from the email body conforms to one or more integration specifications associated with the lead management system. Such integration specifications may have been provided to the sales lead source. In some implementations, the integration specifications may be specific to the type of sales lead, the type of sales lead source, the sales lead source, and/or other parameters. In response to an indication that the sales lead information provided at 2302 conforms with one or more integration specifications, the lead management system may process the sales lead information. The sales lead information may be processed in accordance to process 2100 illustrated in FIG. 21 and/or in accordance to process 2200 illustrated in FIG. 22.

FIG. 24 is a process flow diagram 2400 illustrating aspects of a method having one or more features consistent with implementations of the current subject matter. The process flow illustrated in FIG. 24 may be performed by a lead management system.

At 2401 performance data is provided by one or more buyers/clients. The performance data associated with the performance of sales lead sources previously provided to the buyers/clients. The performance data may be provided in one or more data formats that conform to one or more integration specifications. For example, the performance data may be provided in a text file, a CSV file, in raw format, and/or other formats. The performance data may be arranged in an order that conforms to one or more integration specifications.

At 2402, the lead management system may receive the performance data provided by one or more buyers and/or clients.

At 2404, lead performance data received from the client(s)/buyer(s) may be associated with lead data stored within the lead management system.

At 2405, the lead performance data received from the client(s)/buyer(s) may be used to score the lead data stored within the lead management system.

At 2406, the scored lead data may be fed into scoring and matching algorithms for use at 2106 and/or 2106.

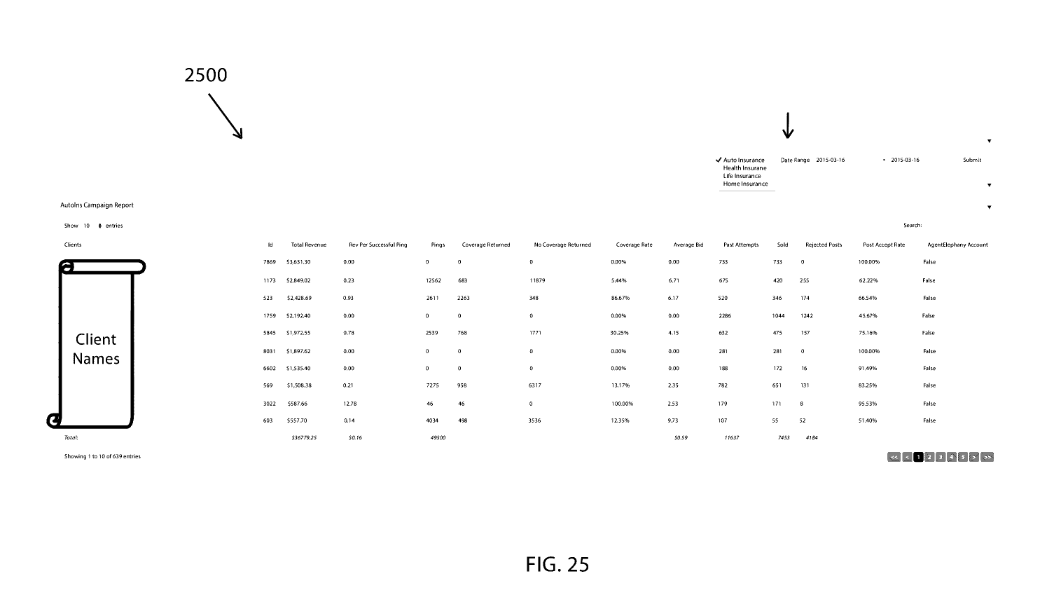

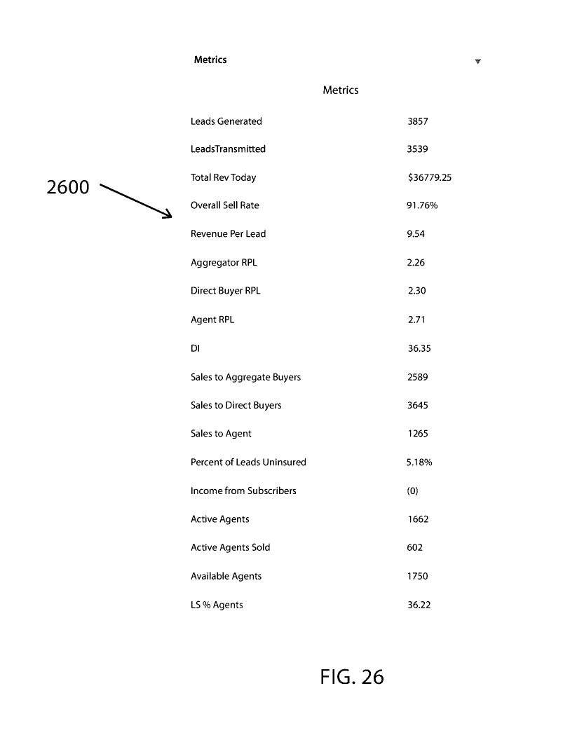

The lead management system may be configured to provide reports. Some of which are described in relation to FIGS. 25-30.

FIG. 25 is an illustration 2500 of lead information across verticals and lead clients that have been generated by a lead management system capable of performing one or more of the operations described herein;

FIG. 26 is an illustration 2600 of key performance indicators for sales leads that have been generated by a lead management system capable of performing one or more of the operations described herein;

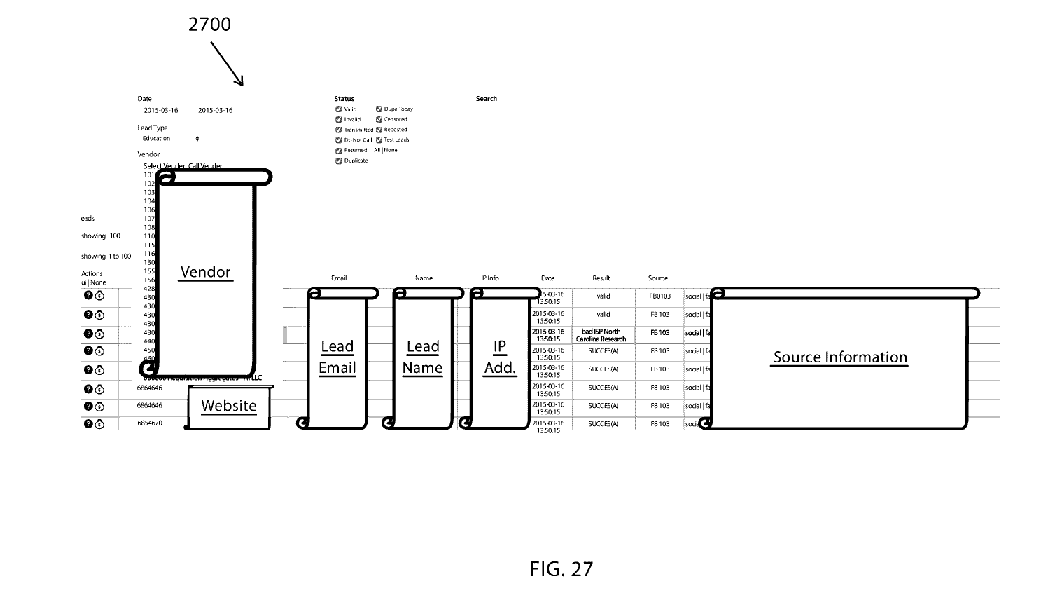

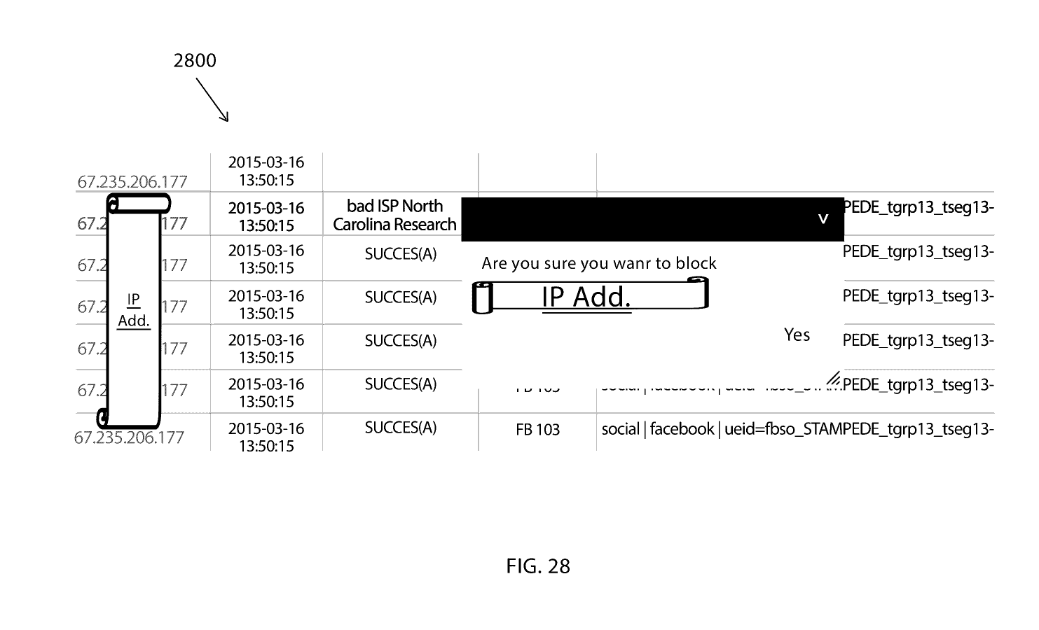

FIGS. 27 and 28 are illustrations 2700 and 2800 of incoming leads that have been received and filtered by a lead management system capable of performing one or more of the operations described herein;

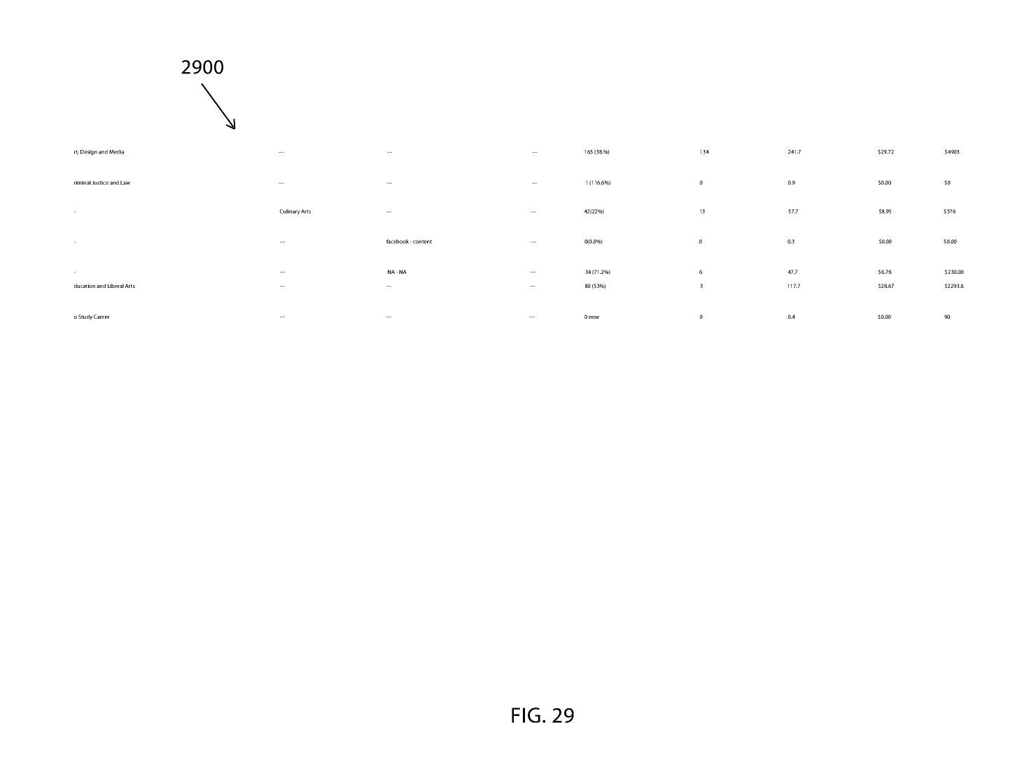

FIG. 29 is an illustration 2900 of lead metrics filtered by different lead attributes that have been generated by a lead management system capable of performing one or more of the operations described herein; and,

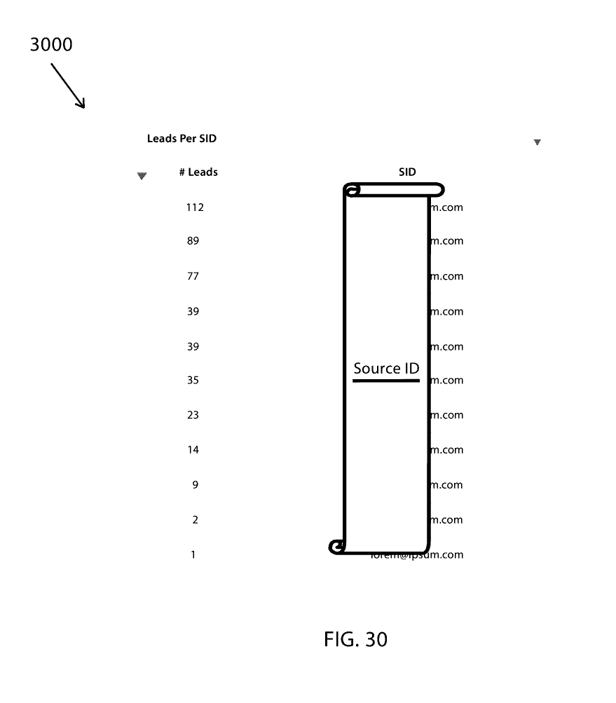

FIG. 30 is an illustration 3000 of leads received by a lead management system capable of performing one or more of the operations described herein.

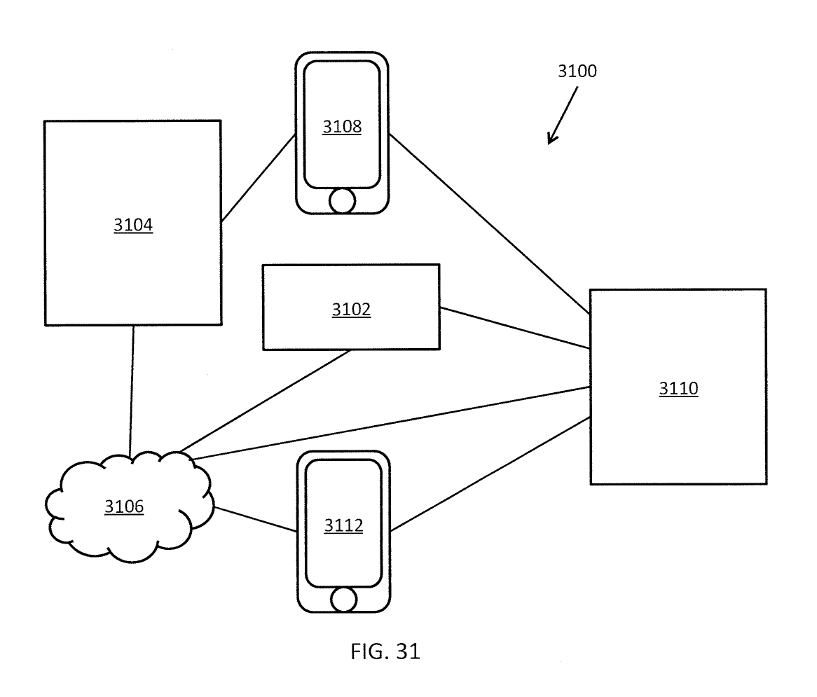

FIG. 31 is an illustration of a system 3100 that facilitates the routing of telephone calls through a lead management system, having one or more features that are consistent with the present disclosure. The system 3100 can be configured to facilitate routing of telephone calls through one or more lead management systems.

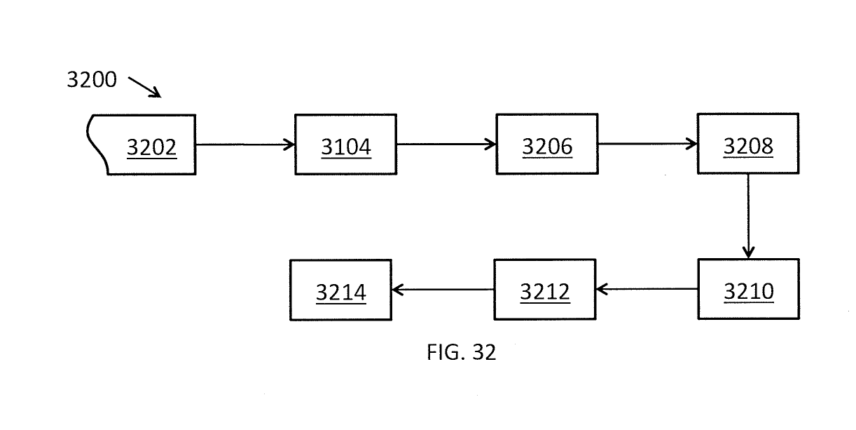

FIG. 32 is an illustration of a process 3200 for routing of a telephone call through a lead management system, having one or more features that are consistent with the present disclosure. At 3202 a vendor 3102 of telephone call sales leads can request, from the lead management system 3104, to match a telephone call based on one or more parameters of the sales lead. The request can be transmitted over one or more communication networks, such as the Internet 3106. The communication networks can have functionality and features similar to the communication networks herein described. The one or more parameters can include one or more of geographic location, age, income, number of vehicles owned, number of cohabiting people, number of cohabiting adults, family income, household income, affiliations, gender, race, historical interaction information, demographic information, wealth, a risk profile, and/or other parameters of the sales lead. The one or more parameters can be specific to a sales lead type of the sales lead. The one or more parameters can be associated with the type of activities conducted by a potential purchaser of the sales lead information. The request from the vendor 3102, can include a portion of the information associated with the sales lead. The one or more sales lead parameters can be used to filter sales lead results. The sales lead vendor 3102 and/or the sales lead management system 3104 can filter the sales leads based on the one or more sales lead parameters.

At 3204, in response to a request from a sales lead vendor 3102 to the lead management system 3104 to match sales leads, the sales lead management system 310 can be configured to determine a bid amount for the sales leads associated with the sales lead information provided by the sales lead vendor 3102. The 3204 the sales lead management system 3104 can transmit the bid amount to the sales lead vendor 3102.

At 3206 the sales lead vendor 3102 can transmit an acceptance of the bid amount to the sales lead management system 3104. At 3206 the sales lead vendor 3102 can transmit additional information associated with the sales lead. The sales lead management system 3104 can validate the sales lead information provided by the sales lead vendor 3102. The sales lead management system 3104 can validate the sales lead information in ways consistent with the present disclosure. The sales lead management system 3104 can validate the sales lead information in other ways.

At 3208 the sales lead management system 3104 can transmit a transfer telephone number to the sales lead vendor 3102. The sales lead vendor 3102 can be in telephone communication with a the sales lead device 3108 associated with the sales lead. The sales lead vendor 3102 can establish a telephone connection with the sales lead device 3108 associated with the sales lead. The telephone connection can be routed through standard telephone networks 3110. The telephone connection can be routed through a network 3106, such as the Internet.

At 3210, the sales lead vendor 3102 can transfer the sales lead device 3108 to a sales lead buyer device 3112 associated with a sales lead buyer. The sales lead buyer and the sales lead can have a telephone conversation.

At 3212, the sales lead management system 3104 can be configured to determine whether or not the telephone call between the sales lead buyer and the sales lead is a billable telephone call. A billable telephone call can be determined based on one or more telephone call parameters. The telephone call parameters can include a duration amount, an outcome and/or other telephone call parameters. For example, in response to a determination that the telephone call lasted in excess of 30 seconds, the sales lead management system can determine that the telephone call is a billable telephone call.

At 3214, in response to determining that the telephone call is a billable telephone call, the sales lead management system 3204 can be configured to provide the sales lead vendor with an outcome of the sales lead telephone call. The outcome can include a duration of the sales lead telephone call, an outcome of the sales lead telephone call, a payment for the sales lead, and/or other parameters. The payment can be an indication of the amount earned for that individual sales lead. The sales lead management system 3104 can be configured to aggregate payment amount for the sales lead source and distribute payments at regular intervals and/or after the aggregate payment amount has reached a threshold.

The lead management system can be configured to centralize the buying of leads and calls from multiple sales lead sellers and/or vendor sources. The lead management system can filter leads based on one or more parameters. The lead management system can be configured to integrate with telecommunication platforms. Examples of telecommunication platforms include, Twillio, Invoca and other telecommunication platforms. The lead management system can be configured to update in real-time or near real-time. When a call is received the lead management system can be configured to automatically update and give the details of the lead source to the consumer of the lead source.

The lead management system and/or telecommunications platform can be configured separately and/or jointly to record the telephone conversations. Information associated with the telephone conversation can be obtained from the telephone conversation. Information can include duration, telephone numbers, identity of participants, identity of a subject(s) of the telephone conversation, an outcome of the telephone conversation, follow-up information associated with the telephone conversation, quality of the telephone conversation, and/or other information. Such information can be associated with the lead source by the lead management system.

The lead management system can be configured to facilitate recording and play back of all calls, and also live calls as they are occurring, to facilitate a boost in quality assurance. Such playback can be performed by a management team member. The lead management system can be configured to combine lead and call buying. The lead management system can be configured to centralize call vendors. Centralizing call vendors can streamline the process and increase access volume of the product. The lead management system can be configured to manage the call orders with one or more filters provided by one or more sources.

The presently described subject matter can be scalable across a team, enterprise, and or other group. The lead management system can be configured to manage calls across a team of agents. The lead management system can be configured to offer bidding model for call vendors (e.g., ping post). The lead management system can be configured to schedule calls. The lead management system can be configured to manage an agency team. The lead management system can be configured to increase and centralize demand for product for vendors. The lead management system can be configured to integrate and/or interface with any telecommunications platform for call providers.

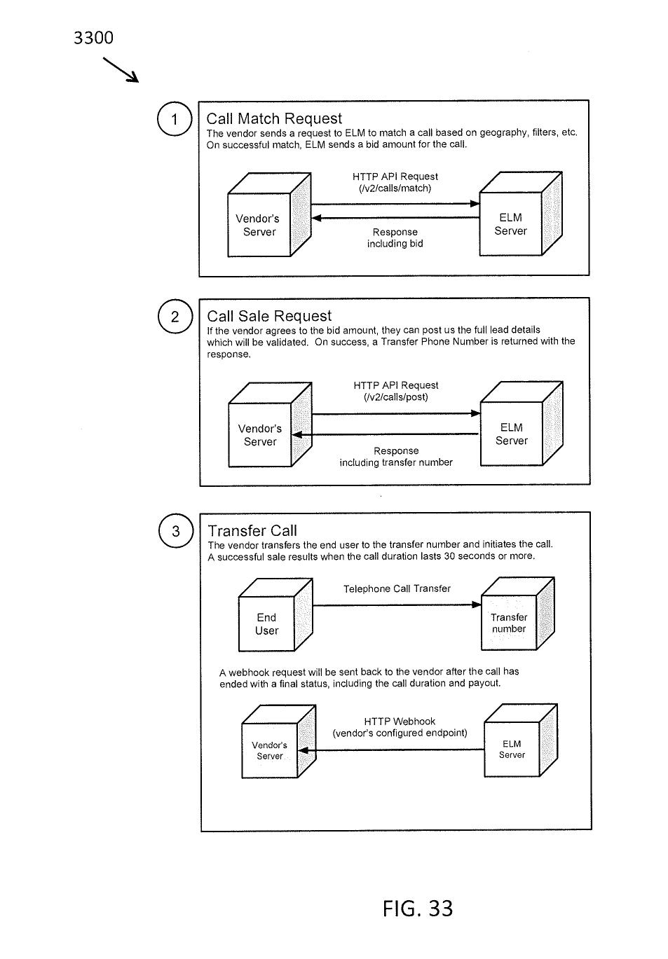

FIG. 33 is an illustration of a process 3300 for routing a telephone-based sales leads through a sales lead management system, having one or more features consistent with the current disclosure.

The present subject matter can be vertically agnostic. Manage sales teams. The sales lead management system can be configured to facilitate the acceptance of calls directly from consumers (click-to-call). Consumers can call a number and be directed straight into the sales lead platform (e.g., internally generated call which takes out the call center). The presently described subject matter contemplates that one or more of the presently described functions can be performed, managed and/or facilitated with the use of a mobile application.

Additional telephonic services can be implemented (e.g. text messaging—consumer clicks on ad mobile phone and local bidding agent sends text to clients). The presently described subject matter can be applied to calls that aren't already online. For example, a consumer sees an add on a billboard and the sales lead management system can be configured to provide a no-answer contingency for a sales team and can include automated voicemail, and/or text service. Automated texting and/or voicemail is contemplated.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying FIG.s and/or described herein do not necessarily require the particular order shown, or sequential order, to achieve desirable results. Other implementations may be within the scope of the following claims.

What is claimed is:

1. A method to be performed by one or more data processors forming at least part of a computing system, the method comprising:
receiving, at the one or more data processors via a communications network, data representing an electronic request from a sales lead vendor system, the electronic request including a subset of information associated with a telephone-based sales lead for matching the telephone-based sales lead with at least one of a plurality of sales lead buyers electronically represented in a database;
selecting, by the one or more data processors according to the subset of information, at least one sales lead buyer from the plurality of sales lead buyers in the database for the telephone-based sales lead, the selecting including a purchase amount to be paid by each of the at least one sales lead buyer the telephone-based sales lead;
transmitting, by the one or more data processors to each of the at least one sales buyer via the communication network, data representing an offer to purchase the telephone-based sales lead at the purchase amount;
receiving, by the one or more data processors from at least one sales lead buyer via the communication network, data representing an acceptance of the offer and additional information associated with the telephone-based sales lead;
executing, by the one or more data processors, a set of verification rules to verify the accuracy of the additional information associated with the telephone-based sales lead;
transmitting, by the one or more data processors to the sales lead vendor via the communications network, data representing a telephone number of the at least one sales lead buyer for enabling the sales lead vendor to transfer the telephone-based sales lead to the at least one sales lead buyer; and,
monitoring, by the one or more data processors, one or more parameters associated with a telephone conversation between the telephone-based sales lead and the sales lead buyer based on the telephone number.

2. The method in accordance with claim 1, further comprising transmitting, via the communication network, an outcome of the telephone call between the telephone-based sales lead and the at least one sales lead buyer to the sales lead vendor.

3. The method in accordance with claim 2, wherein the transmitted outcome includes a duration of the telephone call and an indication of the amount paid to the sales lead vendor for the telephone-based sales lead.

4. The method in accordance with claim 1, further comprising recording the telephone conversation between the telephone-based sales lead and the at least one sales lead buyer.

5. The method in accordance with claim 1, further comprising analyzing the telephone conversations between telephone-based sales lead and the at least one sales lead buyer.

6. The method in accordance with claim 5, further comprising determining a quality assessment of the telephone-based sales leads based on the analysis of the telephone conversations.

7. A non-transitory computer program product storing instructions that, when executed by at least one programmable processor, cause the at least one programmable processor to perform operations comprising:
receiving, at the one or more data processors via a communications network, data representing an electronic request from a sales lead vendor system, the electronic request including a subset of information associated with a telephone-based sales lead for matching the telephone-based sales lead with at least one of a plurality of sales lead buyers electronically represented in a database;
selecting, by the one or more data processors according to the subset of information, at least one sales lead buyer from the plurality of sales lead buyers in the database for the telephone-based sales lead, the selecting including a purchase amount to be paid by each of the at least one sales lead buyer the telephone-based sales lead;
transmitting, by the one or more data processors to each of the at least one sales buyer via the communication network, data representing an offer to purchase the telephone-based sales lead at the purchase amount;
receiving, by the one or more data processors from at least one sales lead buyer via the communication network, data representing an acceptance of the offer and additional information associated with the telephone-based sales lead;
executing, by the one or more data processors, a set of verification rules to verify the accuracy of the additional information associated with the telephone-based sales lead;
transmitting, by the one or more data processors to the sales lead vendor via the communications network, data representing a telephone number of the at least one sales lead buyer for enabling the sales lead vendor to transfer the telephone-based sales lead to the at least one sales lead buyer; and,
monitoring, by the one or more data processors, one or more parameters associated with a telephone conversation between the telephone-based sales lead and the sales lead buyer based on the telephone number.

8. The non-transitory computer program product in accordance with claim 7, further comprising transmitting via the communication network to the sales lead vendor an outcome of the telephone call between the telephone-based sales lead and the at least one sales lead buyer.

9. The non-transitory computer program product in accordance with claim 8, wherein the transmitted outcome includes a duration of the telephone call and an indication of the amount paid to the sales lead vendor.

10. The non-transitory computer program product in accordance with claim 7, further comprising recording the telephone conversation between the telephone-based sales lead and the at least one sales lead buyer.

11. The non-transitory computer program product in accordance with claim 7, further comprising analyzing the telephone conversations between telephone-based sales lead and at least one sales lead buyers.

12. The non-transitory computer program product in accordance with claim 11, further comprising determining a quality assessment of the telephone-based sales leads from the sales lead vendor based on the analysis of the telephone conversations.

13. A system comprising:
at least one programmable processor; and
a machine-readable medium storing instructions that, when executed by the at least one processor, cause the at least one data processor to perform operations comprising:
receiving, at the one or more data processors via a communications network, data representing an electronic request from a sales lead vendor system, the electronic request including a subset of information associated with a telephone-based sales lead for matching the telephone-based sales lead with at least one of a plurality of sales lead buyers electronically represented in a database;
selecting, by the one or more data processors according to the subset of information, at least one sales lead buyer from the plurality of sales lead buyers in the database for the telephone-based sales lead, the selecting including a purchase amount to be paid by each of the at least one sales lead buyer the telephone-based sales lead;
transmitting, by the one or more data processors to each of the at least one sales buyer via the communication network, data representing an offer to purchase the telephone-based sales lead at the purchase amount;
receiving, by the one or more data processors from at least one sales lead buyer via the communication network, data representing an acceptance of the offer and additional information associated with the telephone-based sales lead;
executing, by the one or more data processors, a set of verification rules to verify the accuracy of the additional information associated with the telephone-based sales lead;
transmitting, by the one or more data processors to the sales lead vendor via the communications network, data representing a telephone number of the at least one sales lead buyer for enabling the sales lead vendor to transfer the telephone-based sales lead to the at least one sales lead buyer; and,
monitoring, by the one or more data processors, one or more parameters associated with a telephone conversation between the telephone-based sales lead and the sales lead buyer based on the telephone number.

14. The system in accordance with claim 13, wherein the operations further comprise transmitting, via the communication network, to the sales lead vendor an outcome of the telephone call between the telephone-based sales lead and the one or more sales lead buyers.

15. The system in accordance with claim 14, wherein the transmitted outcome includes a duration of the telephone call and an indication of the amount paid to the sales lead vendor.

16. The system in accordance with claim 13, wherein the operations further comprise recording the telephone conversation between the telephone-based sales lead and the one or more sales lead buyers.

17. The system in accordance with claim 13, wherein the operations further comprise analyzing the telephone conversations between telephone-based sales lead and at least one sales lead buyers.

18. The system in accordance with claim 17, wherein the operations further comprise determining a quality assessment of the telephone-based sales leads from the sales lead vendor based on the analysis of the telephone conversations.
